(19) United States
(12) Patent Application Publication
(10) Pub. No.: US 2025/0297373 A1
(43) Pub. Date: Sep. 25, 2025

(54) MULTISTAGE PROCESSES FOR PLASTIC FUNCTIONALIZATION USING METAL OXIDE CATALYSTS

(71) Applicant: Texas Tech University System, Lubbock, TX (US)

(72) Inventors: Gerardine G. Botte, Lubbock, TX (US); Zenifar Haque, Lubbock, TX (US)

(73) Assignee: TEXAS TECH UNIVERSITY SYSTEM, Lubbock, TX (US)

(21) Appl. No.: 19/223,947

(22) Filed: May 30, 2025

Related U.S. Application Data
(63) Continuation-in-part of application No. 18/011,453, filed on Dec. 19, 2022.
(60) Provisional application No. 63/040,929, filed on Jun. 18, 2020.

(51) Int. Cl. C25B 3/01; B01J 8/02; C25B 3/23

(52) U.S. Cl. CPC C25B 3/01; B01J 8/02; C25B 3/23

(57) ABSTRACT

Methods and systems for functionalizing polymers using a multistage packed bed reactor and transition metal oxide catalysts. A slurry comprising a mixture of plastic particles and a carrier fluid flows through the multistage packed bed reactor, which includes one or more catalyst beds containing metal oxide catalysts such as CuO, Cu₂O, NiO, Fe₂O₃, MnO₂, COO, CrO, VO, transition metal oxides, and combinations thereof. An applied potential between the anode and cathode of the reactor generates in-situ metal oxide catalysts, promoting the introduction of functional groups, including C—O, C═C, C═O, and OH bonds to create functionalized polymers. The functionalized polymers exhibit enhanced chemical reactivity and are suitable for various applications, including biomedical uses and membrane analytical devices. The process also allows catalyst recovery through electrodeposition, enabling sustainable and efficient plastic upcycling into high-value products.

### CROSS REFERENCE TO RELATED PATENT APPLICATIONS

This continuation-in-part application claims priority to U.S. Non-Provisional application Ser. No. 18/011,453, filed Dec. 19, 2022, entitled “Processes For Electrochemical Up-Cycling Of Plastics And Systems Thereof,” which claims priority to PCT Application No. PCT/US2021/038060, filed on Jun. 18, 2021, entitled “Processes For Electrochemical Up-Cycling Of Plastics And Systems Thereof”, which claims priority to U.S. Provisional Patent Application Ser. No. 63/040,929, filed on Jun. 18, 2020, entitled “Processes For Electrochemical Up-Cycling Of Plastics And Systems Thereof,” and which patent applications are commonly owned by the owner of the present invention. These patent applications are hereby incorporated by reference in their entirety for all purposes.

### STATEMENT OF FEDERALLY FUNDED RESEARCH

This disclosure is related to federally sponsored research and development under the government funding from the Department of Energy, Office of Science, Office of Basic Energy Sciences, Award No. DE-SC0022307

The invention was made with United States government support. The United States government has certain rights in the invention.

### TECHNICAL FIELD

The present invention relates to the field of polymer up-cycling and systems thereof, and more particularly to processes for electrochemical up-cycling of plastics and systems thereof.

### BACKGROUND

The present invention addresses the problem of plastic waste management, a significant environmental and economic challenge. To date, global plastic production has reached approximately 8,300 million metric tons (Mt). As of 2015, 6,300 Mt of plastic waste had been generated, with a substantial portion—approximately 79%—accumulating in landfills or the natural environment, and only about 9% being recycled. The remainder, approximately 12%, was incinerated. Current projections indicate that by 2050, an estimated 12,000 Mt of plastic waste may be deposited in landfills or dispersed in natural ecosystems. This trend poses severe risks to human health and the environment.

Among existing recycling methods, mechanical recycling is the most widely employed. However, its broader application is limited due to the production of low-quality materials that restrict their reuse. In contrast, upcycling technologies present a transformative approach to resource recovery, with the potential to generate economic opportunities estimated at approximately $175 billion. The need for efficient plastic upcycling remains a complex technological challenge that intersects environmental sustainability and economic innovation.

Previously attempted methods often require extreme processing conditions, limiting their practical application. Polymer upcycling through methods such as Fenton/photo-electro-Fenton processes typically necessitate a pre-functionalization step and rely on harsh chemicals that are neither environmentally friendly nor scalable. Consequently, there is a critical need for scalable, efficient functionalization techniques to convert plastic waste into high-value products.

Plastics are ubiquitous in modern life. They are made from synthetic carbon-based polymers—organic macromolecules made up of many repeating subunits called monomers—and are designed to be durable and resistant to degradation as well are low cost to produce. The rate of plastics production is currently higher than 400 million metric tons per year (over 8 billion metric tons produced in the past 50 years), with only 20% of used plastics mechanically recycled. [UNEP 2018]. The remainder of the billions of metric tons of plastic produced in the world has been dumped into landfills and oceans, causing serious environmental, health and economic damage.

The properties that make plastics useful, are also responsible for their difficult degradation once they are discarded as waste. Efficient technologies for revalorization of waste polymers could lead to recovering 3.5 billion barrels of oil per year ($175B at $50/barrel), opening opportunities for novel domestic manufacturing. [Celik 2019].

Chemical recycling converts polymers to molecular intermediates that can be used to make new products, creating new value chains for what is currently a waste stream. However, current deconstruction approaches either degrade the properties of the feedstock or are too energy intensive. Polymer upcycling, in contrast, aims at selectively deconstructing polymers into value-added products under mild conditions. [USDOE 2019]. However, current methods for polymer upcycling are highly energy intensive, require separations of products (which impacts process costs by ˜40-50%); and the capital costs for production when compared to the processing capacity.

Current deconstruction approaches either degrade the properties of the feedstock or methods for polymer upcycling are highly energy intensive, require separations of products, which impacts process costs by 40-50%. Current methods include thermal cracking, incineration, and disposing in landfills. Incineration recovers only about half of the energy saved by recycling, biodegradation of current plastics can take hundreds of years, and mechanical recycling—a process of melting and extruding the material—downgrades polymers, limiting their recycle rate.

Moreover, current waste management processes, consisting of mechanical recycling and incineration to recuperate energy, are only capable of handling around 40% of the plastic waste produced worldwide, while the rest is disposed of in landfills and ecosystems, posing severe threats to the environment and circular economy. [Geyer 2019]. The largest fraction of such waste is polyethylene and polypropylene, which have remarkable kinetic and thermodynamic stability. As a result, common strategies for depolymerizing polyolefins are based on high temperature pyrolysis, supercritical water, and hydrogenolysis. [Das 2017]. These approaches, however, are not compatible with the principles of delocalized chemical processing and sustainable chemical manufacturing. Successful conversion approaches will have to produce value-added, easy to transport, products with near zero waste and carbon footprint. Electrochemical depolymerization and upgrading of plastics is a promising approach for plastics upcycling as it can utilize renewable electricity to create an external potential, which can shift the system out of equilibrium. Thus, an electrochemically driven process can overcome the thermodynamic constraints that the endothermicity of the C—C bond cleavage imposes to low-temperature polymer conversion. [Möhle 2018; Rafiee 2019; Kärkäs 2018]. However, fundamental research on the mechanistic aspects of chemistry behind such process is lacking.

Therefore, modular and scalable methods that enable the production of high value products from mixtures of plastics are needed.

### SUMMARY OF THE INVENTION

The present invention is directed to processes for electrochemical up-cycling of plastics and systems thereof. Polymer upcycling aims at selectively deconstructing polymers into value-added products under mild conditions. In embodiments of the present invention, the processes transform recalcitrant polymers and mixtures of plastics into high value chemicals (hydrogen, gasolines, monomers) and high value oxy-hydrogenated char that can be further processed into value products via biological and thermal processes.

The present invention targets plastic upcycling by electrochemically depolymerizing plastics and converting them into monomers and fuels and/or value-added molecules, leading to a circular economy of plastics. A slurry including a mixture of solid plastics flows through an electrochemical cell/anode, which converts into pure hydrogen, fuels, gasolines, and oxygen hydrogenated compounds that can be used for the synthesis of advanced materials and/or for easier biochemical/thermal degradation. A cell voltage is applied between the anode and the cathode of the cell. It is believed that this is the first time a cell voltage is applied to de-polymerize plastics. The present invention enables to use plastic waste to be converted into fuels, chemicals, and products of higher quality or value.

The present invention overcomes the challenge of plastic waste upcycling by using sustainable, green chemistry methods, to selectively implement electrochemical functionalization and deconstruction of polymers (such as low-density polyethylene (LDPE)) at room temperature, low applied potential such as at 1 V), and mild reaction media by low cost first row transition metals electrocatalysts.

In some embodiments, the present invention provides for the functionalization of polymers (such as LDPE) enabled by shuttle electrode/electrolyte pairs and applied electric potential via three different electrocatalysts (Ni, Cu, Fe) in the mild reaction conditions. This process includes reacting the polymer with redox species formed between two electrodes oscillating between opposing polarities in undivided electrochemical cells. One advantage of the proposed approach is that dissolution or melting of the polymer is not a prerequisite for upcycling, whereas the selection of electrolyte, applied potential, oscillation frequency, electrode composition, and operating temperature provides a unique level of control over the degree of depolymerization, functionalization, and the composition of the products.

In general, in one embodiment, the invention features a method for electrochemical up-cycling of polymers. The method includes preparing a slurry comprising a mixture of plastic particles. The method further includes flowing the slurry into an electrochemical cell. The electrochemical cell includes (A) a cathode in a cathode compartment and (B) an anode in an anode compartment. The slurry is flown through the anode compartment. The method further includes providing a medium selected from a group consisting of (i) an electrolyte (in which (A) the electrolyte is flowable though the cathode of the electrochemical cell, and (B) the electrochemical cell further includes a membrane or separator between the anode and the cathode) and (ii) protons that can be pumped from decomposition of the plastic particles in the slurry from the anode and reduced at the cathode. The method further includes providing a voltage or current between the anode and the cathode of the electrochemical cell. The method further includes oxidizing the plastic particles in the slurry to prepare a product selected from a group consisting of fuels, chemicals, oxy-hydrogenated products, and combinations thereof.

Implementations of the invention can include one or more of the following features:

The product can be selected from a group consisting of pure hydrogen, gasolines, monomers, and combinations thereof.

The product can be an oxygen hydrogenated compound that can be used for at least of one the synthesis of materials and biochemical/thermal degradation.

The slurry can be a mixture of plastics and polymers.

The slurry can be formed by grinding plastics.

The slurry can further include the electrolyte.

The particle size of the plastic particles can be in a range of about 10 microns and about 2000 microns.

The anode can include a conductive material support selected from a group consisting of Ni gauze/mesh, Ti, stainless steel, Ni—Cr-MO alloys, graphite, nickel foam, Ti foam, aluminum, aluminum foam, and combinations thereof.

The anode can include a conductive material support selected from a group consisting of carbon, carbon fibers, and graphene.

The anode can include a catalyst that includes a metal selected from a group consisting of Ni, Fe, Co, Cr, Mo, Pt, Rh, Ru, Pd, Ir, combinations thereof, and composites of graphene metal combinations.

The loading of the catalyst can be in a range between 0.1 mg/cm² and 2 mg/cm².

The anode can include a catalyst that includes carbon material selected from a group consisting of carbon fibers, carbon paper, carbon cloth, graphene, and carbon nanotubes.

The anode can be a carbon fiber electrode that includes a Pt electrocatalyst.

The anode can be a Ni mesh electrode.

The cathode can include a conductive material support selected from a group consisting of Ni gauze/mesh, Ti, stainless steel, Ni—Cr-MO alloys, graphite, nickel foam, Ti foam, aluminum, aluminum foam, and combination thereof.

The cathode can include a conductive material support selected from a group consisting of carbon, carbon fibers, carbon paper, carbon cloth, and graphene.

The cathode can include an electrocatalyst that includes a material selected from a group consisting of carbon, graphene, Ni, Fe, Co, Mo, Pt, Rh, Ru, Pd, Ir, and combinations thereof.

The electrochemical cell can include the electrolyte.

The electrochemical cell can include the membrane.

The membrane can include nafion or fritted glass.

The electrochemical cell can include the separator.

The separator can include polyethylene.

The electrolyte can include an acid.

The acid can be sulfuric acid or phosphoric acid.

The acid can be at a concentration in a range of 0.1 M and 9 M.

The electrolyte can include a catalytic additive.

The catalytic additive can include an additive selected from a group consisting of Fe⁺², Fe⁺³, Cr⁺², Cr⁺³, V⁺³, V⁺², and salts thereof.

The catalytic additive can be at a concentration in a range of 10 mM and 1000 mM.

The electrochemical cell can include an additive.

The electrochemical cell can further include a reference electrode.

The reference electrode can include a material selected from a group consisting of Pt, Ni, Au, Ag/AgCl, Ag, and combinations thereof.

The step of oxidizing the plastic particles can occur while controlling temperature in a range between 20° C. and 180° C.

In general, in another embodiment, the invention features a system for electrochemical up-cycling of polymers. The system includes a slurry reservoir containing a slurry that includes a mixture of plastic particles. The system further includes an electrochemical cell. The electrochemical cell includes (A) a cathode in a cathode compartment and (B) an anode in an anode compartment. The electrochemical cell is operatively connected to the reservoir to provide for slurry to flow through the anode compartment. The system further includes a medium selected from a group consisting of (i) an electrolyte (in which (A) the electrolyte is flowable though the cathode of the cell, and (B) the electrochemical cell further includes a membrane or separator between the anode and the cathode) and (ii) protons that can be pumped from decomposition of the plastic particles in the slurry from the anode and reduced at the cathode. The system further includes a cell controller that is operable to control voltage or current between the anode and the cathode of the electrochemical cell. The electrochemical cell, the medium, and the cell controller are operable for oxidizing the plastic particles in the slurry to form a product. The product is selected from a group consisting of fuels, chemicals, oxy-hydrogenated products, and combinations thereof. The system further includes one or more product reservoirs operatively connected to the electrochemical cell to receive the product.

Implementations of the invention can include one or more of the following features:

The product can be selected from a group consisting of pure hydrogen, gasolines, monomers, and combinations thereof.

The product can be an oxygen hydrogenated compound that can be used for at least of one the synthesis of materials and biochemical/thermal degradation.

The slurry can be a mixture of plastics and polymers.

The slurry can be ground plastics.

The slurry can further include the electrolyte.

The particle size of the plastic particles can be in a range of about 10 microns and about 2000 microns.

The anode can include a conductive material support selected from a group consisting of Ni gauze/mesh, Ti, stainless steel, Ni—Cr-MO alloys, graphite, nickel foam, Ti foam, aluminum, aluminum foam, and combinations thereof.

The anode can include a conductive material support selected from a group consisting of carbon, carbon fibers, and graphene.

The anode can include a catalyst that includes a metal selected from a group consisting of Ni, Fe, Co, Cr, Mo, Pt, Rh, Ru, Pd, Ir, combinations thereof, and composites of graphene metal combinations.

The loading of the catalyst can be in a range between 0.1 mg/cm² and 2 mg/cm².

The anode can include a catalyst that includes carbon material selected from a group consisting of carbon fibers, carbon cloth, graphene, and carbon nanotubes.

The anode can be a carbon fiber electrode that includes a Pt electrocatalyst.

The anode can be a Ni mesh electrode.

The cathode can include a conductive material support selected from a group consisting of Ni gauze/mesh, Ti, stainless steel, Ni—Cr-MO alloys, graphite, nickel foam, Ti foam, aluminum, aluminum foam, and combination thereof.

The cathode can include a conductive material support selected from a group consisting of carbon, carbon fibers, carbon paper, carbon cloth, and graphene.

The cathode can include an electrocatalyst that includes a material selected from a group consisting of carbon, graphene, Ni, Fe, Co, Mo, Pt, Rh, Ru, Pd, Ir, and combinations thereof.

The electrochemical cell can include the electrolyte.

The electrochemical cell can include the membrane.

The membrane can include nafion or fritted glass.

The electrochemical cell can include the separator.

The separator can include polyethylene.

The electrolyte can include an acid.

The acid can be sulfuric acid or phosphoric acid.

The acid can be at a concentration in a range of 0.1 M and 9 M.

The electrolyte can include a catalytic additive.

The catalytic additive can include an additive selected from a group consisting of Fe⁺², Fe*³, Cr⁺², Cr⁺³, V⁺³, V⁺², and salts thereof.

The catalytic additive can be at a concentration in a range of 10 mM and 1000 mM.

The electrochemical cell can include an additive.

The electrochemical cell can further include a reference electrode.

The reference electrode can include a material selected from a group consisting of Pt, Ni, Au, Ag/AgCl, Ag, and combinations thereof.

The system can further a heater and a temperature controller that is operably connected to, and operable to control, the heater. The heater and the temperature controller can be operable to control the temperature in the electrochemical cell during oxidation of the plastic particles in the slurry to form the product.

The heater and temperature control can be operable for controlling temperature in a range between 20° C. and 180° C.

The one or more product reservoirs can be selected from a group consisting of gas collectors, condensers, containers, pumps, and combinations thereof.

In general, in another embodiment, the invention features a method for electrical oxidation of a polymer. The method includes dispersing a polymer in an electrolyte including an electrocatalyst to form a slurry. The method further includes utilizing an electrochemical cell to selectively functionalize and deconstruct the polymer in the slurry at room temperature. The electrochemical cell includes two electrodes with the slurry therebetween. The electrochemical cell is utilized by applying a low potential between the two electrodes. The low potential is modulated with a predetermined switching frequency.

Implementations of the invention can include one or more of the following features:

The electrocatalyst can include a first row transition metal.

The electrocatalyst can be selected from a group consisting of Ni, Cu, Fe, and combinations thereof.

The electrochemical cell can be a bipolar single chamber packed bed electrolysis cell.

The two electrodes can be selected from a group consisting of copper, nickel, and stainless steel electrodes.

The polymer can include low-density polyethylene (LDPE).

The method can further include using an acid to adjust the pH of the electrolyte to approximately neutral.

The concentration of the polymer dispersed in the slurry can be between 10 mg to 20 mg per 1 ml of the electrolyte.

The predetermined switching frequency can be between 5 to 15 seconds.

The low potential can be between 0.5 to 1.5 V.

The selective functionalization of the polymer can be selected from a group consisting of (i) direct electrooxidation mediated by organometallic complexes, (ii) indirect electrooxidation via ionic strength modulated by potential control, (iii) direct electrooxidation led by pre-adsorbed ions, (iv) indirect oxidation via electro-Fenton, and (v) combinations thereof.

In general, in another embodiment, the invention feature a system for electrical oxidation of a polymer. The system includes a slurry including a polymer dispersed in an electrolyte comprising an electrocatalyst. The system further includes an electrochemical cell including two electrodes with the slurry therebetween. The system further includes a cell controller that is operable to apply a low potential between the two electrodes. The low potential is modulated with a predetermined switching frequency. The application of the low potential is operable to selectively functionalize and deconstruct the polymer in the slurry at room temperature.

Implementations of the invention can include one or more of the following features:

The electrocatalyst can include a first row transition metal.

The electrocatalyst can be selected from a group consisting of Ni, Cu, Fe, and combinations thereof.

The electrochemical cell can be a bipolar single chamber packed bed electrolysis cell.

The two electrodes can be selected from a group consisting of copper, nickel, and stainless steel electrodes.

The polymer can include low-density polyethylene (LDPE).

The method can further include using an acid to adjust the pH of the electrolyte to approximately neutral.

The concentration of the polymer dispersed in the slurry can be between 10 mg to 20 mg per 1 ml of the electrolyte.

The predetermined switching frequency can be between 5 to 15 seconds.

The low potential can be between 0.5 to 1.5 V.

The selective functionalization of the polymer can be selected from a group consisting of (i) direct electrooxidation mediated by organometallic complexes, (ii) indirect electrooxidation via ionic strength modulated by potential control, (iii) direct electrooxidation led by pre-adsorbed ions, (iv) indirect oxidation via electro-Fenton, and (v) combinations thereof.

In general, in another embodiment, the invention features a method for functionalizing polymers. The method includes preparing a slurry comprising a mixture of plastic particles and a carrier fluid. The method includes flowing the slurry into a multistage packed bed reactor. The multistage packed bed reactor has one or more catalyst beds, wherein the one or more catalyst beds comprise a metal oxide catalyst selected from CuO, Cu₂O, NiO, Fe₂O₃, MnO₂, CoO, CrO, VO, transition metal oxides, and combinations thereof. The multistage packed bed reactor has an anode and a cathode. The multistage packed bed reactor has a separator positioned between the anode and the cathode. The slurry is flown through at least one of the one or more catalyst beds. The method includes applying a voltage between the anode and the cathode to generate metal oxide catalysts in situ within the reactor. The method includes oxidizing the plastic particles in the slurry. The method includes introducing one or more functional groups comprising C—O, C═C, C═O, OH, and combinations thereof to create a functionalized polymer. The method includes recovering the functionalized polymer.

Implementations of the invention can include one or more of the following features:

The carrier fluid is an electrolyte.

The method further includes controlling the temperature within a range of 20° C. to 130° C. during the step of oxidizing the plastic particles in the slurry.

The voltage is a pulsed potential modulated between −0.45 V and −0.25 V.

The voltage controller is configured to use switching frequencies of about 5, 10, 30 seconds.

The functionalized polymer is further processed using electro-Fenton techniques to generate fatty acids, fuels, or monomers.

The one or more functional groups comprise both the C═C and the C═O.

The catalyst bed is in the form of a porous mesh or foam.

The method further includes the step of recovering dissolved catalysts from the carrier fluid using electrodeposition.

The plastic particles comprise low-density polyethylene (LDPE) or polypropylene (PP).

The plastic particles have a particle size in the range of about 10 microns to about 2000 microns.

The carrier fluid comprises an aqueous medium selected from the group consisting of potassium hydroxide, sodium hydroxide, sulfuric acid, copper sulfate, nickel sulfate, and combinations thereof.

The carrier fluid further comprises an additive selected from the group consisting of lactic acid, ethylenediaminetetraacetic acid (EDTA), and surfactants.

In general, in another embodiment, the invention features a system for functionalizing polymers. The system includes a slurry reservoir configured to contain a slurry comprising plastic particles and a carrier fluid. The system includes a multistage packed bed reactor. The multistage packed bed reactor includes a plurality of stages, each stage containing a catalyst bed containing a metal oxide catalyst selected from a group consisting of CuO, Cu₂O, NiO, Fe₂O₃, MnO₂, CoO, CrO, VO, transition metal oxides, and combinations thereof, an anode and a cathode, and a separator positioned between the anode and cathode. The system includes a voltage controller operable to apply a voltage between the anode and cathode to generate in-situ metal oxide catalysts. The system includes a temperature controller operable to maintain a reaction temperature between 20° C. and 130° C. The system includes a pump configured to flow the slurry through the reactor. The system includes one or more product reservoirs operatively connected to the reactor to collect a functionalized polymer.

Implementations of the invention can include one or more of the following features:

The carrier fluid is an electrolyte.

The voltage controller is configured to supply a pulsed potential modulated between −0.45 V and −0.25 V.

The voltage controller is configured to use switching frequencies of about 5, 10, 30 seconds.

The catalyst bed is in the form of a porous mesh or foam.

The plastic particles comprise low-density polyethylene (LDPE) or polypropylene (PP).

The plastic particles have a particle size in the range of about 10 microns to about 2000 microns.

The carrier fluid comprises an aqueous medium selected from the group consisting of potassium hydroxide, sodium hydroxide, sulfuric acid, copper sulfate, nickel sulfate, and combinations thereof.

The carrier fluid further comprises an additive selected from the group consisting of lactic acid, ethylenediaminetetraacetic acid (EDTA), and surfactants.

In general, in another embodiment, the invention features a functionalized polymer product, produced by methods disclosed herein. The functionalized polymer product has a polymer backbone comprising one or more functional groups selected from a group consisting of C—O, C═C, C═O, OH, and combinations thereof. The one or more functional groups are introduced into the polymer backbone through an electrochemical process utilizing metal oxide catalysts selected from a group consisting of CuO, Cu₂O, NiO, Fe₂O₃, MnO₂, CoO, CrO, VO, transition metal oxides, and combinations thereof.

### DESCRIPTION OF DRAWINGS

FIG. 1 is schematic diagram of a process for electrochemical depolymerization and upcycling of plastics of the present invention.

FIGS. 2A-2B are photographs of (FIG. 2A) carbon fiber electrodes with Pt electrocatalysts, and (FIG. 2B) a Ni mesh electrode that can be used in embodiments of the present invention.

FIG. 3 is a schematic of a rig for the electrolysis of polymers in the present invention.

FIG. 4 is a graph showing current density at constant voltage (1.17 V) for Pt and Ni electrodes.

FIG. 5 is a graph showing FTIR spectrum of electrooxidized LDPE at different conditions.

FIG. 6 is a graph showing GC/MS data of organic products dissolved in the electrolyte after the electrolysis with: (plot 601) Pt electrode with 1 M H₂SO₄ at 95° C., (plot 602) Pt electrode with 4 M H₂SO₄ at 105° C., (plot 603) Ni electrode with 1 M H₂SO₄ at 90° C.

FIG. 7A is an illustration of a packed bed electrolysis cell for electrochemical upcycling of LDPE.

FIG. 7B is a graph showing the switch of polarity utilized for the packed bed electrolysis cell shown in FIG. 7A.

FIG. 8 are graphs showing the FTIR spectra of LDPE samples in the region of 800 cm⁻¹ to 1400 cm⁻¹ for pristine, after 2 hours chemical treatment in different electrolyte solutions at room temperature, and after 2 hours electrolysis at room temperature.

FIG. 9 are graphs showing the FTIR spectra of LDPE samples in the region of 1500 cm⁻¹ to 2000 cm⁻¹ for pristine, after 2 hours chemical treatment in different electrolyte solutions at room temperature, and after 2 hours electrolysis at room temperature.

FIG. 10 are graphs showing the FTIR spectra of LDPE samples in the region of 3000 cm⁻¹ to 4000 cm⁻¹ for pristine, after 2 hours chemical treatment in different electrolyte solutions at room temperature, and after 2 hours electrolysis at room temperature.

FIGS. 11A-11D are schematics for direct electrooxidation mediated by organometallic complexes proposed oxidation mechanism.

FIG. 12 is a schematic for indirect electrooxidation via ionic strength modulated by potential control.

FIG. 13 show direct electrochemical oxidation mechanisms of polyolefins via water discharge reaction.

FIG. 14 is a schematic for indirect oxidation radical mechanism (electro-Fenton chemistry).

FIG. 15 shows mechanisms for Fenton chemistry initiated by hydrogen and oxygen.

FIG. 16 illustrates the electro-assisted hydrolysis setup, comprising a three-electrode electrochemical cell with a nickel mesh electrode serving as the working electrode.

FIG. 17 depicts the kinetic analysis of PET depolymerization products.

FIG. 18 demonstrates the conversion efficiency of PET depolymerization under various applied potentials.

FIG. 19 depicts, the production of EG and TPA from different PET particle sizes and formate production with corresponding yield percentages across particle sizes.

FIG. 20 illustrates a schematic diagram of the process, with detailed views of stages containing pre-synthesized catalysts and in-situ generated catalysts.

FIG. 21 depicts the structural and design elements of the process, in accordance with embodiments of the present disclosure.

FIG. 22 illustrates the Fourier Transform Infrared (FTIR) analysis of the LDPE samples after both the chemical and electrochemical experiments.

FIG. 23A depicts the formation of the black catalyst after both chemical and electrochemical experiments. FIG. 23B depicts the two surfaces formed on the electrode used in the electrochemical experiment.

FIG. 24 presents the EDX analysis of the copper sheet and the black paste after the treatment.

FIGS. 25A-25D show the experimental setup and results of the functionalization process using CuO and Cu₂O catalysts. FIG. 25A and FIG. 25C display the functionalization of LDPE with CuO and Cu₂O catalysts, respectively. FIG. 25B and FIG. 25D depict the corresponding FTIR quantification of the functional groups formed, respectively.

FIG. 26 shows the catalytic roles of CuO and Cu₂O in LDPE functionalization.

FIG. 27A shows the formation of the Cu₂O layer on the titanium electrode. FIG. 27B depicts the SEM image revealing the crystalline structure of Cu₂O. FIG. 27C presents a comparison with the known crystalline framework of Cu₂O from literature, confirming the structure. FIG. 27D illustrates the EDS imaging results, showing a 2:1 ratio of copper to oxygen, consistent with the composition of Cu₂O.

### DETAILED DESCRIPTION

The present invention is related to polymer up-cycling and systems thereof, and more particularly to processes for electrochemical up-cycling of plastics and systems thereof. The processes of the present invention transform recalcitrant polymers and mixtures of plastics into high value chemicals (hydrogen, gasolines, monomers) and high value oxy-hydrogenated char that can be further processed into value products via biological and thermal processes.

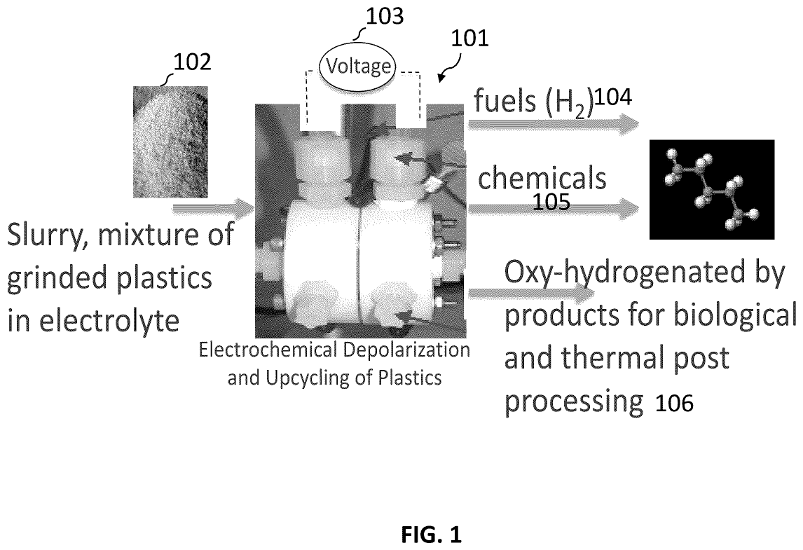

FIG. 1 is schematic diagram of a process for electrochemical depolymerization and upcycling of plastics of the present invention. Such decarbonization leads to the production of H₂ and other valuable chemicals, as well as products for further processing as advanced materials.

In general, the process shown in FIG. 1 involves the following steps:
(a) An electrochemical cell 101 containing an anode, cathode, and a membrane or separator are integrated, such as shown in FIG. 1.
(b) A slurry 102 prepared by a mixture of grinded plastics and electrolyte is flown through the anode compartment of the electrochemical cell 101.
(c) An electrolyte is flown through the cathode of the cell (if using a membrane), or protons are pumped from the decomposition of the components from the anode and reduced at the cathode.
(d) A cell voltage 103 is applied between the anode and cathode of the electrochemical cell 101.
(e) The plastic slurry 102 is oxidized producing high value chemicals such as gasolines, monomers, methane, high value chemicals, and a high value char. A general reaction is depicted in Eq. (1).

2n˜(C)+2H₂O→2n(C—OH)+2H⁺+2e⁻ (1)
(f) Pure hydrogen is produced at the cathode of the cell according to the reaction Eq. (2).

2H⁺+2e⁻→H₂ (2)

The most recalcitrant plastics—such as polyethylene, polypropylene, and polyvinyl chloride—lack oxygen groups, which makes these polymers highly stable but difficult to recycle. The presence of oxy-hydrogenated bonds depicted in Eq. (1) makes the char left from the process highly recyclable and an important feedstock for the synthesis of advanced materials such as graphene, carbon nanotubes, monomers, etc.

The process of the present invention enables the low temperature hydrolysis of plastics producing lower molecular weight macromolecules, hydrogen, fuels and chemicals of value. Other transformational advantages include: (1) selectivity for the removal/oxidation of additives included in the product (most plastics contain additives that create complexity during their recycling); (2) direct application of electrons for breaking bonds in the chain of the polymeric structure; (3) tolerance to hybrid mixtures of plastics, which minimizes separation of plastic wastes; (4) implementation of renewable sources of energy (solar, wind); (5) co-generation of high value products such as H₂, chemicals, fuels; (6) and modularity (which makes the process eligible for distributed processing of plastics into high value chemicals).

It is believed that this is the first time a cell voltage is applied to de-polymerize plastics. It is further believed that the electrochemical up-cycling of solid plastic slurries have not been reported. Hori 2020 reported a study on the use of plastic waste as a feedstock for fuel cell applications. Hori et al. focused on the implementation of polymers that can be solubilized in acid electrolytes at relatively high temperatures (˜200° C.) such as polyurethane, nylon, and vinylon. They demonstrated the conversion of the different polymers into electricity using phosphoric acid as electrolyte and platinum electrocatalyst supported in mesoporous carbon. When the polymer was dissolved in an electrolyte at high temperature, it was typically decomposed, acting as an organic chemical in the fuel cell. In addition, the type of polymers used dissolve because they contain oxygen groups in the change. Hori et al. reported the production of carbon dioxide at the anode with traces of methane. The approach reported by Hori et al. worked only for solubilized polymers and not for insoluble and/or solid slurries.

### Electrochemical Cell

The electrochemical cell of the present invention can include (a) an anode, (b) a cathode, (c) a membrane or separator, and (d) electrolyte or additive. In some embodiments, the electrochemical cell may further include a reference electrode.

### Anodes

Examples of anodes utilized in embodiments of the present invention can include:

Anodes constituted by a conductive material support, e.g., Ni gauze/mesh, Ti, stainless steel, Ni—Cr-MO alloys (such as Hastelloy metal), graphite, nickel foam, Ti foam, aluminum, aluminum foam, etc. Generally, the anodes can be formed from any conductive material while being resistance to corrosion based on the electrolyte, cell voltage, and temperature of the system.

Other supports for the anodes include carbon, carbon fibers, carbon paper, carbon cloth, and graphene.

The catalyst for the anode can include metals such as Ni, Fe, Co, Cr, Mo, Pt, Rh, Ru, Pd, Ir, and combinations thereof, and composites of graphene metal combinations. The loadings can be in the range of 0.1 mg/cm² and 2 mg/cm².

In some embodiments, the catalyst is a carbon material, such as carbon fibers, carbon paper, carbon cloth, graphene, and carbon nanotubes.

### Cathode

Examples of cathodes utilized in embodiments of the present invention can include:

Cathodes constituted by a conductive material support, e.g., nickel gauze/mesh, Ti, stainless steel, Ni—Cr-MO alloys (such as Hastelloy metal), graphite, carbon paper, carbon cloth, graphene, etc. Generally, the cathodes can be formed from any conductive material while being resistance to corrosion based on the electrolyte, cell voltage and temperature of the system.

Electrocatalyst of the cathode can be made of materials including, carbon, graphene, Ni, Fe, Co, Mo, Pt, Rh, Ru, Pd, Ir, and combinations thereof.

Membrane and/or Separator

The electrochemical cell of the present invention can contain a membrane, such as nafion, fritted glass, etc., and/or separators, e.g., polyethylene.

### Electrolyte and Additives

Electrolytes/additives utilized in the present invention can be acid including strong and weak acids, e.g., sulfuric acid, phosphoric acid, etc. The concentrations can be in the range of 0.1 M and 9 M (depending on the electrolyte and their solubility in the solvent).

The electrolyte can contain catalytic additives such as Fe⁺², Fe⁺³, Cr⁺², Cr⁺³, V⁺³, V⁺², etc. The concentrations of the salt/additives can be in the range of 10 mM and 1000 mM.

### Reference Electrode

In some embodiments of the present invention, the potential can be applied versus a reference or pseudo reference electrode. For example, the reference electrode can be made of a material such as Pt, Ni, Au, Ag/AgCl, Ag, and combinations thereof.

### Process For Electrochemical Up-Cycling

Generally, the process of the present invention includes:
(a) The slurry 102 is flowed through the anode of the cell 101;
(b) The electrolyte can be recirculated through the cathode of the cell 101;
(c) Cell voltage 103 is applied between the anode and the cathode of the cell. In some embodiments, alternatively, current is applied instead of a voltage; and
(d) Temperature is controlled during the process.

This electrochemical depolarization and upcycling of plastics process (such as shown in FIG. 1) can convert plastic waste to into fuels (such as H₂) 104, chemicals 105, and products of higher quality or value (such as oxy-hydrogenated by-products for thermal post processing 106).

### Slurry

The slurry 102 can be prepared from a mixture of plastics and/or polymers.

In some embodiments, the particle size of plastics can be in the range of about 10 microns and about 2000 microns.

In some embodiments, the slurry is a mixture of plastics and electrolyte and/or additives.

### Cell Voltage

Generally, cell voltage 103 of up to 1.5V can be applied, depending on the type of electrolyte use and the temperature. A goal is to prevent water oxidation at the anode of the cell 101. Oxidation potential is a function of the electrolyte and temperature used.

### Temperature

Generally, the temperature is controlled to be within the range of 20° C. and 180° C.

### Example Processes

### Electrochemical Cell and Rig Examples

Examples of electrolysis methods were performed using low density polyethylene (LDPE) powder with 500 micron particles size (supplied by Alfa Aesar, ACS #9002-88-4), with a melting point of 190° C. and density of 0.9220 g/ml. [ThermoFisher 2020].

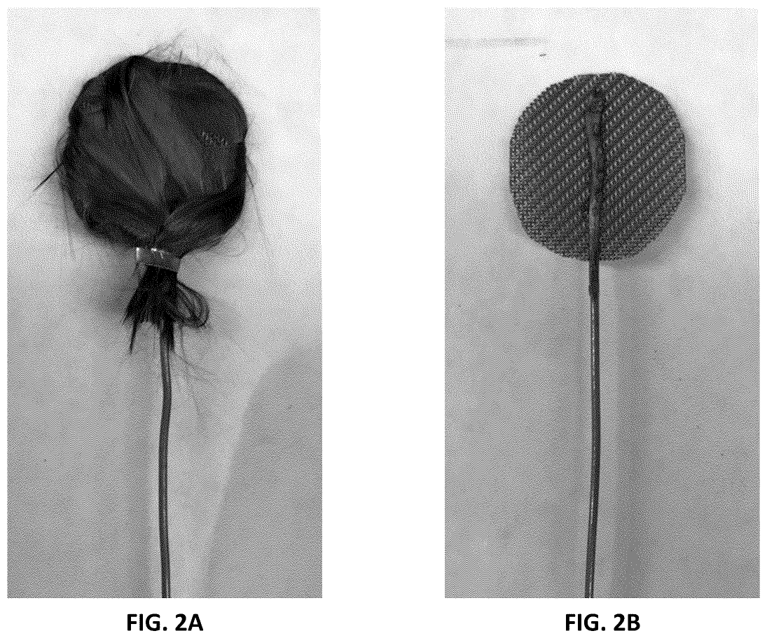

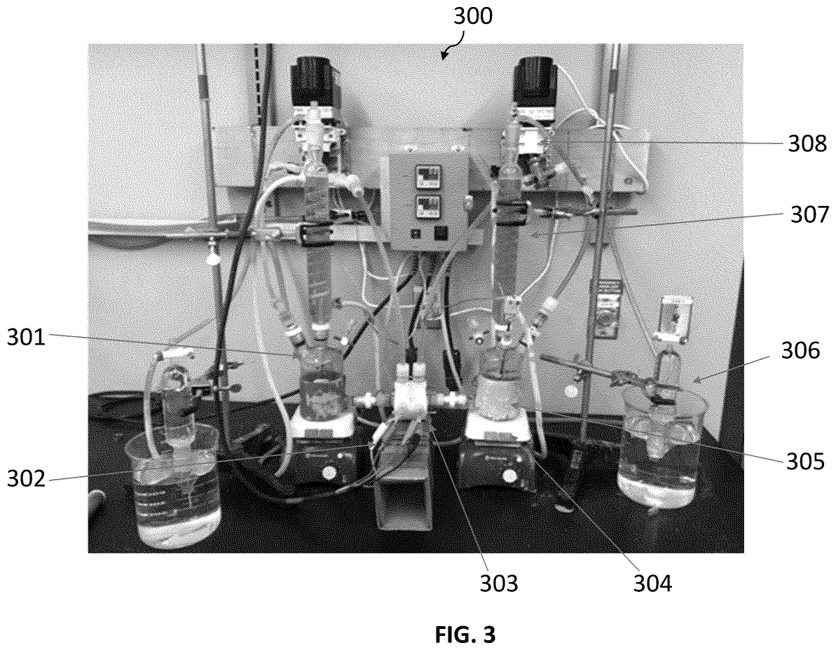

A slurry dispersion was created by mixing the powder plastic with electrolyte, in this case, sulfuric acid. The dispersion of the slurry was affected by the velocity. An electrochemical cell 303 and rig 300 for the electrolysis were built as shown in FIGS. 2A-2B and 3.

Two anode electrode configurations were tested, shown in FIGS. 2A-2B, respectively, with FIG. 2A showing a carbon fiber electrode with Pt electrocatalysts and FIG. 2B showing a Ni mesh electrode. Nickel mesh, and carbon fibers (support, BASF polyacrylonitrile-PAN-carbon fiber from Celion G30-500, 7 micron diameter) spray coated with Pt (using nafion as the binder) nanocatalyst (loading of 1 mg/cm²) supported on Vulcan XC-72R prepared by the polyol method through ethylene glycol reduction reaction. [Li 2017].

In all the cases, the cathode was prepared by spray coating of Pt on Vulcan/nafion ink on carbon fibers with a loading of 1 mg/cm². Nafion 117 was used to separate the anodic and cathodic compartments of the electrolysis cell 303 (shown in FIG. 3). Both Ni and Pt electrocatalysts represent a spectrum of possibilities for the electrolysis of polyethylene (PE).

Schematic of the rig 300 is shown in FIG. 3. Rig 300 includes (a) slurry/plastic dispersion container 301 (which contains the slurry/plastic dispersion), (b) connectors 302 to voltage controller, (c) electrolysis cell 303, (d) stirring plates 304, (e) temperature heaters and controllers 305, (f) gas collectors 306, (g) condensers 307, and (h) pumps 308. Rig 300 can be used to enable control of temperature, applying cell voltage (or current), and quantification and collection of gases produced (by water displacement).

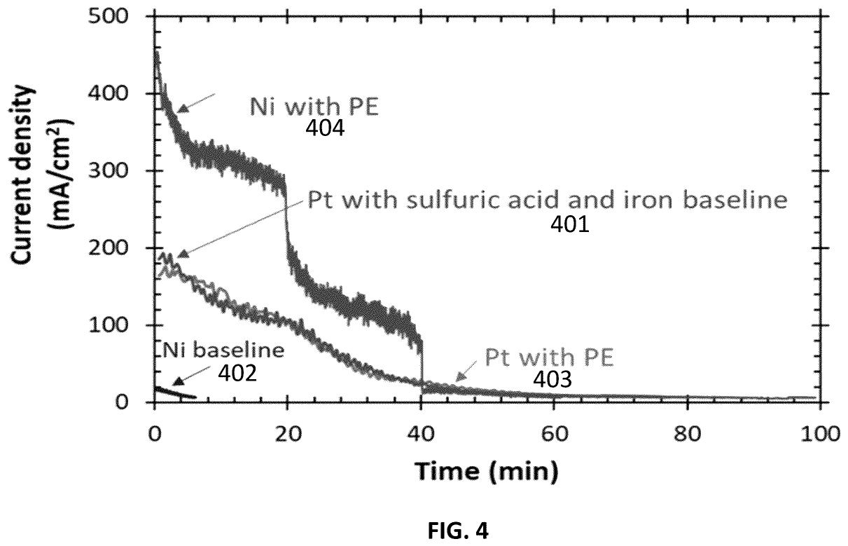

Utilizing rig 300, electrolysis was performed using sulfuric acid as electrolyte at 90-105° C. at a constant cell voltage of 1.17 V (to prevent water electrolysis and oxidation of the carbon electrode support). Electrolysis with the Pt electrode (shown in FIG. 2A) included 40 mM of Fe²⁺/Fe³⁺ to start the reaction. The electrochemical response of the system is shown in FIG. 4. Plots 401-402 are, respectively, the Pt with sulfuric acid and iron baseline and Ni baseline. Plots 403-404 are, respectively, the Pt with polyethylene (PE) and Ni with PE.

In all cases when PE slurry was present, oxidation currents were observed (i.e., electrochemical oxidation of the PE was observed in both Pt and Ni based electrodes). For the Ni electrode, no significant corrosion was observed with the blank electrolyte, and the current density increased significantly when PE was added into the solution. At that point, some dissolution of the Ni electrode was observed. The current dropped abruptly due to pump dis-control, which was later fixed. For the Pt electrode, the change observed was slightly higher than for the oxidation of Fe²⁺, indicating some oxidation of the LDPE. In both cases, hydrogen gas was produced at the cathodic compartment of the cell, demonstrating reaction (2).

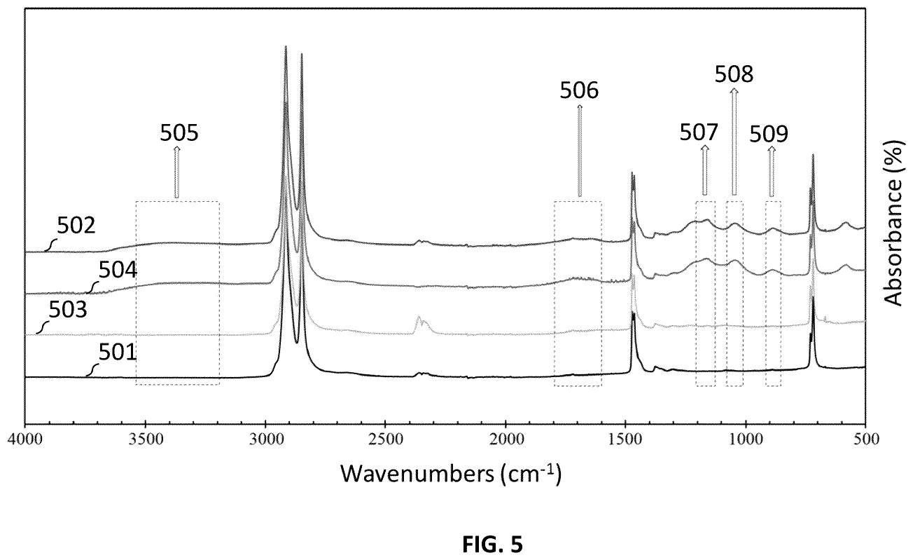

Ex-situ Fourier Transform Infrared (FTIR) was conducted to evaluate the oxidation of the polymer after electrolysis, which results are shown in FIG. 5 (showing FTIR spectrum of electrooxidized LDPE at different conditions, with presence of carboxylic groups and OH are observed after electrolysis). Plots 501-504 are, respectively, the plots for (501) raw PE, (502) Ni electrode, (503) Pt electrode (95° C., 1 M H₂SO₄), and (504) Pt electrode (105° C., 4 M H₂SO₄). FTIR spectra were collected in the wave numbers of 500-4000 cm⁻¹.

The electrolyzed product from the Ni electrode shows significant oxidation and the presence of oxygen-hydrogenated groups: OH-stretching due to hydroperoxide, or alcohol functional groups (3400 cm⁻¹) (shown in box 505), C═O bonds indicate carboxylic, aldehydes, ketones, or esters functional groups (1700 cm⁻¹) (shown in box 506), C—O bonds at 1200 cm⁻¹ are an indication of ether functional groups (shown in box 507), OC—O—CO vibrations at 1050 cm⁻¹ are an indication of anhydride groups (shown in box 508), and C═C bending at 900 cm⁻¹ can be an indication of alkenes functional groups (shown in box 509). The significant oxidation and the presence of —OH groups confirm the electrochemical oxidation of PE. For the Pt electrode, mild oxidations of PE are observed at 95° C. with 1 M H₂SO₄ (plot 503) but much higher oxidation is observed at 105° C. with 4 M H₂SO₄ (plot 504).

Analysis of the products in the electrolyte was performed via combined gas chromatography/mass spectrometry, in which the organic compounds were extracted on dichloromethane from the electrolyte. Plots 601-603 are, respectively, plots of GC/MS data of organic products dissolved in the electrolyte after the electrolysis with: (601) Pt electrode with 1 M H₂SO₄ at 95° C., (602) Pt electrode with 4 M H₂SO₄ at 105° C., and (603) Ni electrode with 1 M H₂SO₄ at 90° C. Peaks of plots 601-603 are for (a) peaks 606 for benzene (C₆H₆), (b) peaks 607 for heptane (C₆H₁₆), (c) peaks 608 for octane (C₈H₁₈), (d) peaks 612 for dodecane (C₁₂H₂₆), (e) peaks 614 for tetradecane (C₁₄H₃₀), (f) peaks 615 for pentadecane (C₁₅H₃₂), (g) peaks 618 for octadecane (C₁₈H₃₈), (h) peaks 620 for eicosane (C₂₀H₄₂), and (e) peaks 622 for docosane (C₂₂H₄₆).

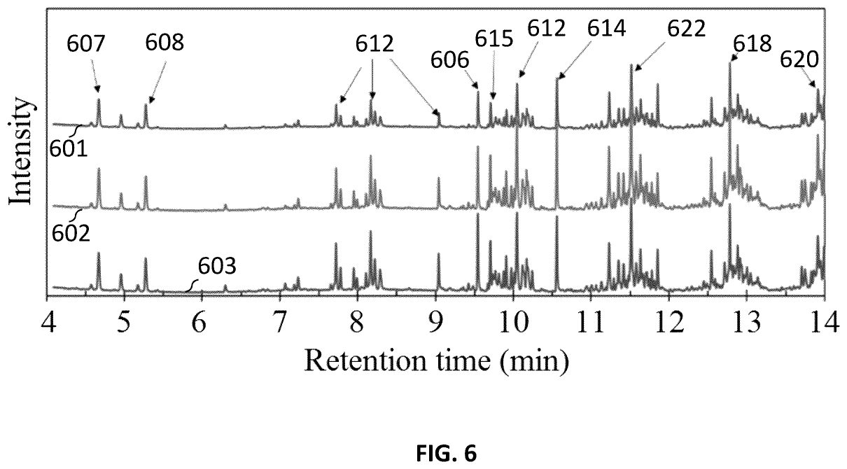

The results shown in FIG. 6 confirm the oxidation of LDPE into smaller chain hydrocarbons and gasoline type byproducts for both the Ni and Pt electrodes. Rheological tests performed in the electrolyzed LDPE with the Ni electrode indicate a 35% decrease in the viscosity, which is associated with a decrease in the molecular weight in the polymer.

### Bipolar Single Chamber Packed Bed Electrochemical Cell Examples

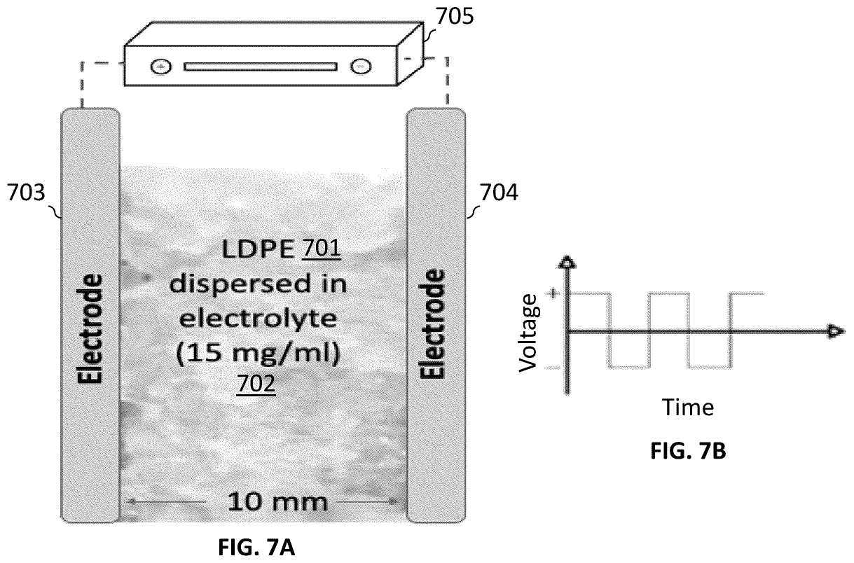

Further examples were performed using low-density polyethylene (LDPE) powder with 500-micrometer particle size (supplied by Alfa Aesar) in a bipolar single chamber packed bed electrolysis cell designed to maintain the contact between the polymer, the electrolyte, and the electrodes, as shown in FIG. 7A. In FIG. 7A, the electrodes geometric area was 4 cm². LDPE 701/electrolyte 702 was held in contact with electrodes 703-704. The image of LDPE 701 in NiSO₄ electrolyte is a photograph in FIG. 7A.

LDPE 701 was dispersed in the electrolyte 702 at a concentration of 15 mg LDPE per mL of electrolyte. The cell included identical metal electrode couples 703-704, i.e., copper (0.01 in. thick, 99.9% metals basis, supplied by Alfa Aesar), nickel (0.01 in. thick, 99.9% metals basis, supplied by Alfa Aesar), and 304 stainless steel (SS) (0.03 in. thick, supplied McMaster-Carr) foils, and operated at 25° C., with the applied cell voltage modulated by potentiostat 705 between ±1V having a polarity switching frequency of 10 seconds (as shown in FIG. 7B). Electrolysis time was kept at 2 hours.

Electrolytes consisted of 1M CuSO₄, 1M NiSO₄, and 1M FeSO₄/Fe₂(SO4)₃ (all analytical grade, purchased from Fisher Chemicals) for the Cu, Ni, and SS electrode couples, respectively. The pH of the electrolyte was adjusted to zero using sulfuric acid (analytical grade, purchased from Fisher Chemicals). All the materials used as received and these examples have been performed without applying potential to study the chemical effect of electrolytes on the oxidation of LDPE. The average current densities for Cu, Ni, and SS electrodes were 120, 10.5, and 2.7 (mA/cm²), respectively.

At the operating cell potential, copper dissolution and deposition were observed (1% wt. lost per hour). In the case of nickel, dissolution of Ni and hydrogen evolution were observed (3.75% wt. lost per hour). No weight loss was observed in the SS electrode as the applied cell potential was not enough to trigger dissolution of the alloy.

After electrolysis, the LDPE particles were removed from the electrolyte by vacuum filtration, properly rinsed to remove residual electrolyte, and dried in a vacuum oven at 40° C. for 18 hours. To evaluate the oxidation of the polymer after electrolysis, Fourier Transform Infrared (FTIR) was conducted on Bruker Optics Vertex 70 spectrometer (256 scans, resolution of 2 cm⁻¹) equipped with a 45° single reflection Bruker Optics Platinum A225 attenuated total reflection (ATR) unit having diamond crystal in the range of 400-4000 cm⁻¹ at room temperature.

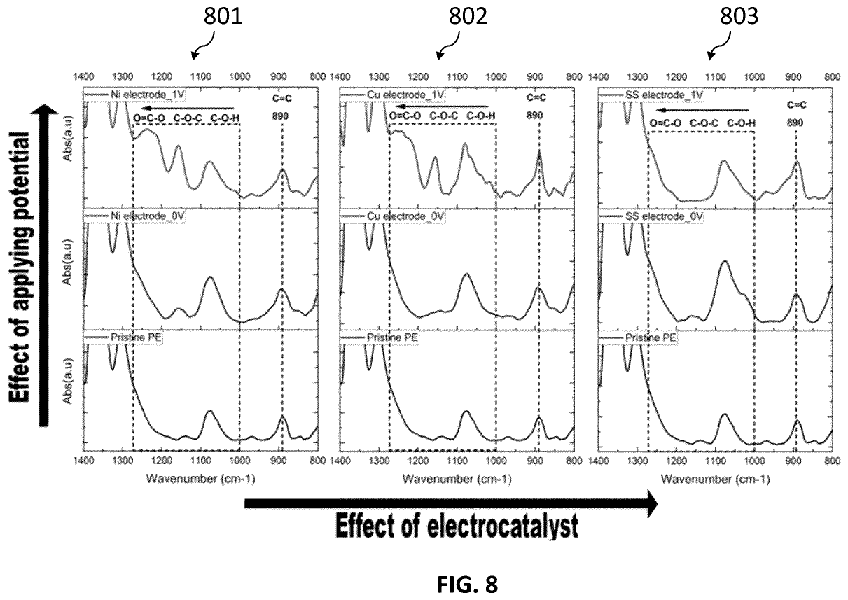

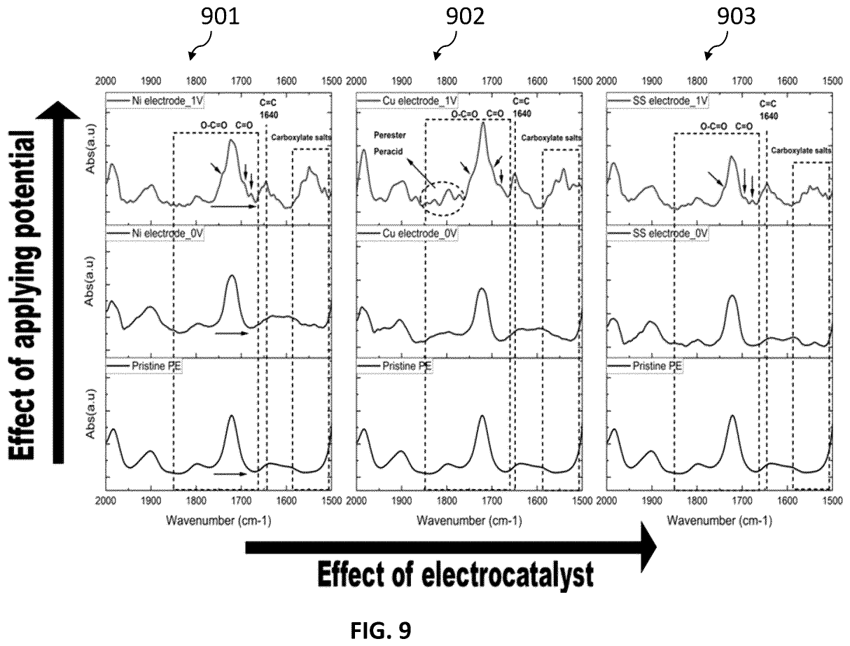

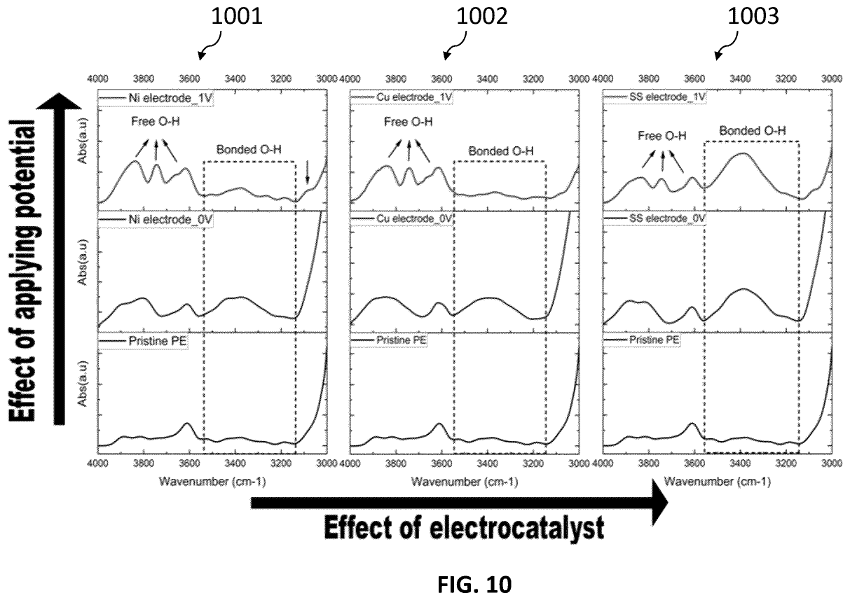

The penetration depth into the sample is on the order of 0.5 to 2 m. See FIGS. 8-10. FIG. 8 shows the FTIR spectra 801-803 of LDPE samples in the region of 800 cm⁻¹ to 1400 cm⁻¹ for pristine (bottom spectra), after 2 hours chemical treatment in different electrolyte solutions at room temperature (middle spectra), and after 2 hours electrolysis at room temperature (top spectra), having ±1V cell potential in different electrodes and electrolytes for Ni electrodes/Ni salt solution (spectra 801), Cu electrodes/Cu salt solution (spectra 802), and SS electrodes/Fe salt solution (spectra 803). FIG. 9 shows the FTIR spectra 901-903 of LDPE samples in the region of 1500 cm⁻¹ to 2000 cm⁻¹ for pristine (bottom spectra), after 2 hours chemical treatment in different electrolyte solutions at room temperature (middle spectra), and after 2 hours electrolysis at room temperature (top spectra), having ±1V cell potential in different electrodes and electrolytes for Ni electrodes/Ni salt solution (spectra 901), Cu electrodes/Cu salt solution (spectra 902), and SS electrodes/Fe salt solution (spectra 903). FIG. 10 shows the FTIR spectra 1001-1003 of LDPE samples in the region of 3000 cm⁻¹ to 4000 cm⁻¹ for pristine (bottom spectra), after 2 hours chemical treatment in different electrolyte solutions at room temperature (middle spectra), and after 2 hours electrolysis at room temperature (top spectra), having ±1V cell potential in different electrodes and electrolytes for Ni electrodes/Ni salt solution (spectra 1001), Cu electrodes/Cu salt solution (spectra 1002), and SS electrodes/Fe salt solution (spectra 1003).

FTIR spectra show bands in the regions 1000-1250, 1650-1850, and 3200-3600 cm⁻¹, which are attributed to oxygen-containing functional groups such as C—O, C═O, and O—H, respectively. [Hamzah 2018; Rocha 2009]. Results demonstrate that the functionalization of LDPE is affected by applied potential, electrocatalysts and electrolyte. A detailed description of the FTIR spectra is divided into three regions: (1) C—O and C═C, (2) C═O and C═C, and (3) O—H to facilitate data presentation.

C—O and C═C region: FIG. 8 shows the effect of electrocatalyst (from spectra 801-803) and the effect of applied cell potential (from bottom to top) in the electrooxidation of LDPE. Two small vibrational absorption bands at 890 cm⁻¹ and 1080 cm⁻¹ were observed for the pristine LDPE, which were attributed to the vinylidene (C═C) and the C—O bonds mostly in the form of alcohol (C—OH) or peroxide (R—O—OH) groups. These groups are associated with the LDPE preparation methods and presence of additives in the sample (e.g., primary, and secondary antioxidants). [Chabira 2012; Ruvolo-Filho 2013]. Chemical treatment of LDPE just by electrolyte solutions shows no change in the vinylidene (890 cm⁻¹) peak while a small increase in the intensity of peaks corresponding to the alcoholic/peroxide (1080 cm⁻¹) groups [Zenkiewicz 2003] was observed.

Previous researchers have suggested that electrolytes can incorporate oxygen bonds to the polymer by the adsorption of complexes of transition metal ions at the polymer surface. [Allara 1976; Robertson 2014]. Results of these embodiments showed that LDPE samples treated electrochemically by Cu and Ni electrodes show a higher degree of oxidation as suggested by the appearance of new vibrational bands around 1150 cm⁻¹ and 1230 cm⁻¹, which was attributed to ether and ester groups. [Martinez-Colunga 2020; Tofa 2019]. The Cu electrode showed the best capability to oxidize LDPE because it not only conducted to the generation of new ether and ester vibrational absorption bands, but also led peaks corresponding to the vinylidene and the alcoholic groups get sharper and broader after electrolysis.

Meanwhile, for the SS electrode, compared to the chemical exposure, applying potential only caused a slight decrease in the alcoholic peak and a slight increase for the vinylidene peaks, suggesting that electrolysis provided energy for the creation of iron/polymer complexes leading to the formation of C═C bonds.

C═O, C═C region: FIG. 9 shows FTIR spectrum (spectra 901-903) over the region 1500 cm⁻¹ to 1850 cm⁻¹ is divided into three sub-regions: (i) 1500 cm⁻¹ to 1600 cm⁻¹, (ii) 1600 cm⁻¹ to 1650 cm⁻¹, and (iii) 1650 cm⁻¹ to 1850 cm⁻¹, which are ascribed to the carboxylate salts (COO—), C═C, and C═O functional groups, respectively. [Hamzah 2018; Lens 1997; Sibeko 2014; Yagoubi 2015]. For the pristine LDPE, there was only a peak centered at 1720 cm⁻¹, which indicated the presence of carbonyl species (ketone, carboxylic acid, ester, aldehyde, anhydride), indicating the presence of additives. [Yagoubi 2015]. The formation of carbonyl species was a result of the decomposition of hydroperoxide, ether, or alcohol groups. Accordingly, the formation of carbonyl species led to chain scission, formation of C═C bond, and finally led to decreasing the average molecular weight of the polymer (degradation). [Hamzah 2018; Chabira 2012; Yagoubi 2015; Wang 2009]. Electrochemically treated LDPE spectra, except for SS electrode, show considerable changes for the carbonyl peak, centered at 1720 cm⁻¹, while chemical exposure did not impact on the polymer. Among the three electrocatalysts, the Cu electrode showed a higher capability to lead to the introduction of carbonyl species into the polymer chain, followed by Ni and SS electrodes. C═C peak centered at 1640 cm⁻¹ appeared after electrolysis of LDPE in the three electrodes. The appearance of the peak centered at 1550 cm⁻¹ shoed the formation of carboxylate functional groups after electrolysis.

Hydroxyl (O—H) groups were formed by oxidative degradation of polymers which contain alkyl chains, such as polyolefins. [Sugiura 2000]. A broad peak from 3200 cm⁻¹ to 3550 cm⁻¹ suggested the presence of bonded OH including alcohol groups or hydroperoxides. [Rocha 2009; Abusrafa 2019]. Treatment of samples caused appearance of non-bonded or free hydroxyl groups. [Moore 2008; Quezado 1984; Liu 2013]. Peaks related to these OH groups appeared at the higher wavenumbers (more than 3600 cm⁻¹), and compared to the bonded OH, the peaks were sharper.

Surface entrapped water was one of the main sources of non-bonded OH. However, there was a possibility for the appearance of a peaks between 3700 cm⁻¹ to 3900 cm⁻¹ related to the OH bond in metal hydroxide (M-OH) compounds [Gulmine 2002; Hadjiivanov 2014; Song 2013]. According to the results, see FIG. 10 (specta 1001-1003), pristine LDPE showed a shallow broad peak in the bonded OH region (3200 cm⁻¹ to 3550 cm⁻¹) and a small peak around 3600 cm⁻¹, originating from additives and adsorbed water on the surface of polymer [Gulmine 2002], respectively. Compared to the pristine LDPE, chemically treated samples showed a stronger broad peak in the region of 3200 cm⁻¹ to 3550 cm⁻¹, which can indicate that chemical exposure to the electrolyte has the capability to add hydroperoxide or alcohol groups (primitive oxidation).

Consequently, generation or growth of the peaks at region 3600 cm⁻¹ to 3900 cm⁻¹ showed a higher number of non-bonded OH (or metal hydroxide OH) for the chemically treated samples. It is believed that the residual transitional metal ions (as a catalyst) which were already adsorbed on the polymer surface during the chemical treatment of LDPE are not stable and they turn to the metal hydroxide form. These surface metal hydroxide compounds can facilitate the adsorption of water molecules leading to the appearance of more sharp peaks between 3600 cm⁻¹ and 3900 cm⁻¹.

Except for the SS electrode, electrochemical treatment of LDPE caused vanishing of the broad peak between 3200 cm⁻¹ and 3550 cm⁻¹, which already existed for the chemically treated samples. Observation of this phenomena can show that electrolysis can provide energy for the hydroperoxide, alcohol, and non-reacted residual catalysts on the surface of the polymer to decompose them to other forms of oxygen functional groups like ether, ester, carboxyl, ketone, aldehyde, anhydride (advanced oxidation).

Based on the FTIR spectra from FIGS. 8-10, and the observations from the literature, it is believed that the electrochemical functionalization of LDPE can occur via four different oxidation mechanisms (1) direct electrooxidation mediated by organometallic complexes, (2) indirect electrooxidation via ionic strength modulated by potential control, (3) direct electrooxidation led by pre-adsorbed ions, and (4) indirect oxidation via electro-Fenton.

Direct Electrooxidation Mediated by Organometallic Complexes: Brewis et al. demonstrated the electrochemical functionalization of polymers implementing a strong oxidant acid such as nitric acid at high concentration (3.5 M). [Brewis 2000]. The authors of Brewis 2000 observed direct oxidation of the polymer with the electrode, leading to oxygen containing groups in the backbone of the polymer. [Brewis 2000]. In embodiments of the present invention, sulfuric acid, which is a less strong oxidant than nitric acid, was used at much lower concentrations than the nitric acid reported in the literature. The fact that the presence of a weak and diluted acid was still capable of providing polymer functionalization was surprising and promising and has not previously been reported in the literature.

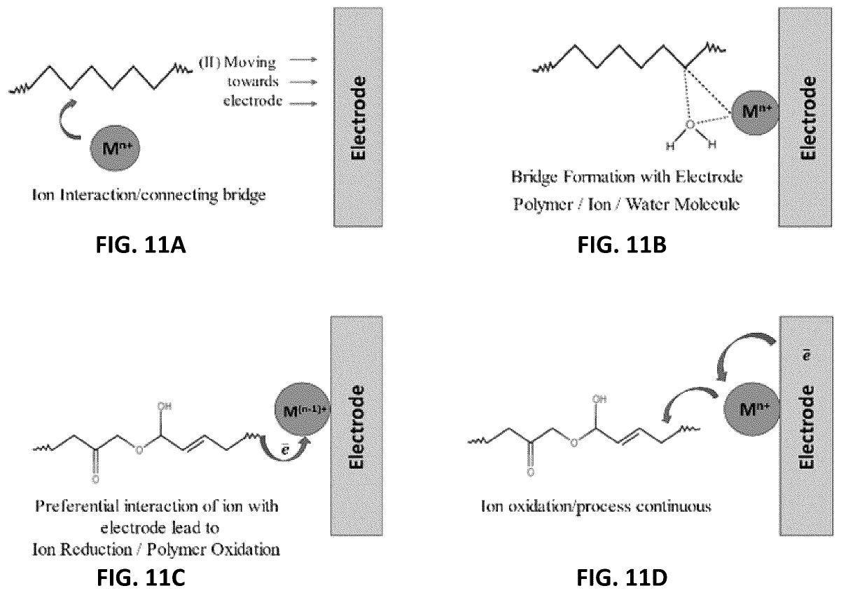

Ionic species in the electrolyte can adsorb on the surface of the polymer and make an interaction because of their polarity. [Allara 1976; Robertson 2014]. The adsorption of such ion complex compounds on LDPE was observed in the FTIR results. Therefore, a mechanism similar to the electrochemical oxidation of complex solid fuels as proposed by Jin and Botte [Jin 2010] can be believed for polyolefins as shown in FIG. 11A-11D. FIGS. 11A-11D are schematics for direct electrooxidation mediated by organometallic complexes proposed oxidation mechanism, namely for: (a) FIG. 11A—ion interaction/connecting bridge; (b) FIG. 11B—bridge formation with electrode polymer/ion/water molecule; (c) FIG. 11C—preferential interaction of ion with electrode lead to ion reduction/polymer oxidation; and (d) FIG. 11D—ion oxidation/process continuous.

Organometallic complexes (metal ion/water) can adsorb on the polyolefins, interact with the electrocatalysts (bridge), in turn, the cation was reduced, and the polymer oxidized (with OH integration in the polymer chain). Due to the interaction with the electrocatalyst, the reduced cation was oxidized and returned to the polymer chain to continue oxidation. The believed mechanism included the complex reaction between polymer particles and transition metal ions on the surface of the electrode and does not require the melting or dissolution of the polymer. Such mechanism can be affected by the particle size of the polyolefins, the contact of the particles with the electrocatalyst, the electrocatalyst composition, and the ionic salts implemented. Cu ions showed more tendency to make a complex with polymers followed by Ni and Fe ions. [Masoud 2015]. The believed mechanism can explain the observation that the Cu electrode was more effective towards the oxidation of LDPE due to the formation of the complex with the polymer, not observed in the SS electrodes.

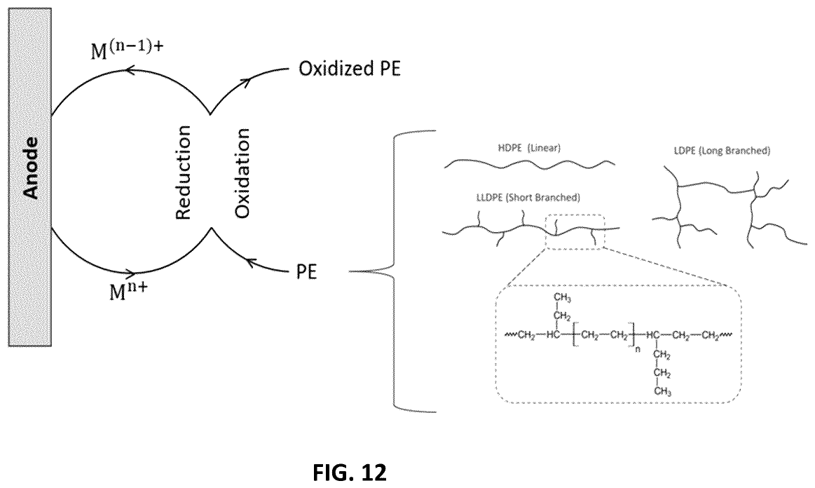

Indirect electrooxidation via ionic strength modulated by potential control: Mediated Electrochemical Oxidation (MEO) of polymers have been reported implementing strong oxidizer ions (AgNO⁺³) and acids (nitric acid) at high concentration. [Brewis 2000]. A mechanism based on MEO can be hypothesized for polyolefins and presented in FIG. 12. In the MEO process, a metal ion in an acid medium is oxidized from its lower oxidation state to a higher oxidation state and this oxidized species triggers C—C/C—H bond cleavage and gets reduced, depending on the complexity of the reactant intermediate chemicals are produced. In the process, metal ion is not consumed in the reaction and acts as a mediator. [Balaji 2007]. MEO was originally established for dissolution of difficult to dissolve forms of plutonium oxide [Chiba 1994], but later was found to be effective for oxidizing many organic materials such as polyolefins. [Brewis 2000].

In the MEO approach, the oxidizer strength of the ions can be important, the oxidizer strengths increase according to Ni⁺²>Cu⁺²>Fe⁺³, which can explain why LDPE was oxidized to a higher extent when Ni⁺² and Cu⁺² were present in the electrode. The current density in the Cu electrochemical cell as higher than for the Ni (10×) and SS electrodes (>40×), therefore the transport and distribution of the ionic charges in the electrolyte is stronger, which can lead to higher oxidation of the polymer. Such a mechanism can be controlled by the strength of the electrolyte, applied potential and frequency of oscillation, type of mediator and electrolyte, current density at the electrodes (affecting charge distribution), and temperature. [Chiba 1994].

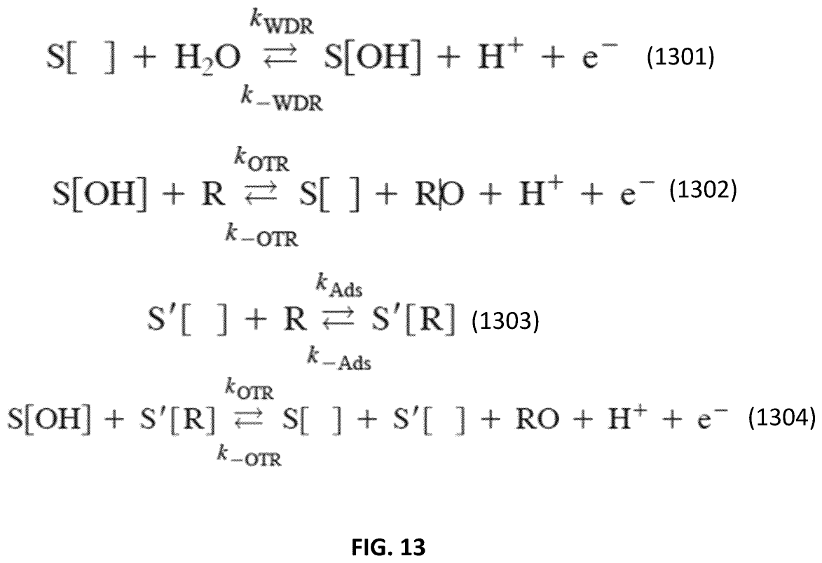

Direct electrooxidation led by pre-adsorbed ions: Direct electrochemical oxidation of organic compounds at potentials below that required for 02 evolution have been reported. [Treimer 2001]. The process is initiated by the hydroxyl radicals (OH) that are generated on the electrocatalyst by the anodic water discharge reaction (WDR). A mechanism for the depolymerization of polyolefins based on WDR is shown in FIG. 13 (reactions 1301-1304). “S[ ]” represents surface sites for adsorption of OH species, “R” is the reactant (e.g., polyolefin), “S′[ ]” represents sites that maybe different to S[ ], and “S′[R]” represents adsorption of reactant, in the case of the polymer, could be enabled by complex cations adsorption on the polymer with preliminary evidence observed in the FTIR and reported in the literature. [Allara 1976; Robertson 2014].

It is believed that the carbon groups in the polyolefins were activated through interaction with metal atoms within the surface lattice followed by OH transfer, leading to depolymerization and functionalization. In embodiments of the present invention, Ni, Cu, and SS electrodes could enable the WDR. Such a mechanism can be affected by the electrocatalyst composition, the oxidation state of the metal catalyst in the electrode support, the contact of the polymer with the electrocatalyst and the particle size of the polymer.

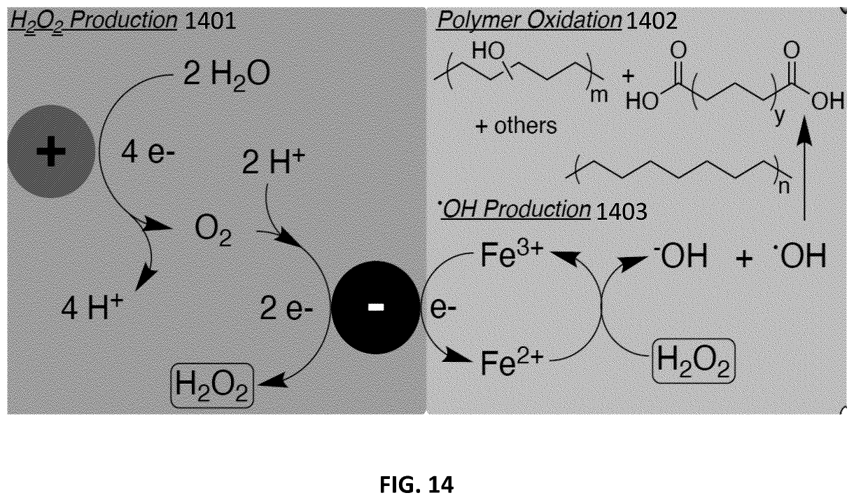

Indirect Oxidation Radical Mechanism (electro-Fenton chemistry): In electro-Fenton chemistry hydrogen peroxide in the presence of transition metal ions can decompose to hydroxyl radicals (OH) which are highly reactive. [Chumakov 2016]. This mighty oxidizer easily reacted with the polymer chain and caused formation of hydroperoxide functional groups. Subsequently, non-stable hydroperoxide functional groups decomposed to the other forms of oxygen functional groups like ether, ester, carboxyl, ketone, aldehyde, anhydride. [Brillas 2009]. It is believed that the electric potential triggers radical chemistry analogous to Fenton processes. Such radicals can, in turn, promote oxidative C—C bond cleavage. As shown in FIG. 14, in a typical electro-Fenton process water is oxidized at an anodic site to oxygen, which is subsequently reduced to H₂O₂(H₂O₂ production 1401). In parallel, electroactive molecular species is formed upon reduction at the cathode. The encounter of H₂O₂ and a Fenton-active species produces the species that initiate an oxidative bond cleavage in the polyolefins (polymer oxidation 1402). The cations that enable the Fenton cycle are likely produced by partial dissolution of the metal electrodes in acidic conditions (OH production 1403).

In embodiments of the present invention results, the cell potential was maintained at 1V, therefore, oxygen evolution was not thermodynamically feasible. However, oxygen could have been dissolved in the electrolyte as the processes of the embodiments were performed in an open cell (see FIG. 7). Both Cu and Ni oxidation states reacted with H₂O₂ and produced hydroxyl radicals. [Chumakov 2016; Torreilles 1990; Zhong 2014]. Additionally, Cu⁺² complexes with organic degradation intermediates (organic acids) are easily decomposed by hydroxyl radicals, whereas the corresponding Fe⁺³ complexes are highly stable. [Bokare 2014]. It is believe that this is one of the reasons for less effectiveness of SS electrode compared to the copper electrode in oxidation of LDPE. The radical Fenton chemistry of the present invention has been proven successful in depolymerizing plastic into short chain commodity chemicals albeit with multiple reaction steps and with external oxidants. [Chow 2016].

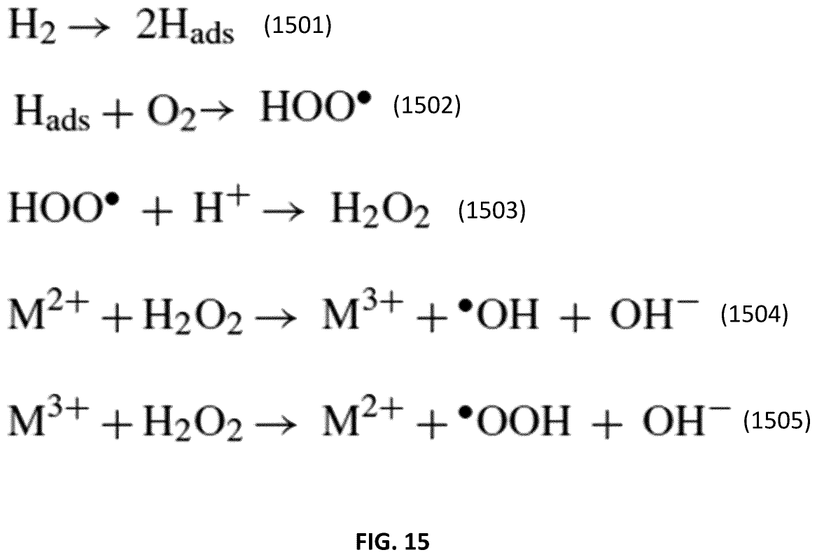

The Fenton chemistry is also initiated by the presence of adsorbed H when hydrogen is produced as shown in FIG. 15 (reactions 1501-1505), where “M” represents the oxidation cations. The Fenton chemistry was affected by the presence of oxygen, the composition of the electrocatalyst, the applied overpotential and the frequency of oxidation, and the oxidizing strength of the cations.

Extended carbon structures, like LDPE (one of the major plastic waste), can be functionalized, oxidized, and upcycled to the value-added chemicals by applying current when they are suspended in solutions containing transition metal salts. Embodiments of the present invention show that polyethylene reacted with low, oscillating, applied electric potentials (in the order of 1.0 V) at room temperature. Upon electrochemical processing, new functional groups appear, and the concentration of others increased as a function of applied potential and electrocatalyst. Cu electrocatalyst showed the highest oxidation of LDPE when compared to Ni and SS.

### Uses

The present invention technology targets plastic upcycling by electrochemically depolymerizing plastics and converting them into monomers and fuels and/or value-added molecules, leading to a circular economy of plastics. A slurry that includes a mixture of solid plastics flows through an electrochemical cell/anode, which converts into pure hydrogen, fuels, gasolines, and oxygen hydrogenated compounds that can be used for the synthesis of advanced materials and/or for easier biochemical/thermal degradation. A cell voltage is applied between the anode and the cathode of the cell; this is the first time a cell voltage is applied to de-polymerize plastics. The present invention enables to use plastic waste to be converted into fuels, chemicals, and products of higher quality or value.

The benefits of the present invention include renewable energy, plastic degradation, and value-added products. Applications of the present invention include recycling, renewable energy, clean energy, and waste management.

As detailed below, further benefits of the present invention include high efficiency, enhanced product yield, low temperature and pressure, and scalability. Specifically, in some embodiments, the use of metal oxide catalysts (from transition metals) significantly reduces reaction time and increases conversion rates compared to non-electrochemical methods. Further, in some embodiments, as detailed below, the formation of NiOOH directly on the electrode surface enables efficient conversion of EG to formic acid.

In certain embodiments, the methods can operate under moderate temperatures and ambient pressure. In some embodiments, the simultaneous production of formic acid, TPA, and hydrogen gas maximizes the value of PET waste. In certain embodiments, the method's modular design allows for distributed processing, making it suitable for both small-scale and industrial applications.

Before the present invention, the most commonly available chemical upcycling methods used thermal cracking processes, which cannot be performed at large scale due to being energy and economy inefficient. The electrochemical innovation described here is modular and is compatible with renewable energy.

### Electro-Assisted Hydrolysis of PET Using Metal Oxide Catalysts

The present invention also encompasses an innovative electro-assisted hydrolysis process for the upcycling of PET plastic waste. This process integrates hydrolysis with electrochemical oxidation, utilizing a metal oxide catalyst (such as for example, but not limited to, CuO, Cu₂O, NiO, Fe₂O₃, MnO₂, CoO, CrO, VO, transition metal oxides, and combinations thereof), specifically nickel oxide (NiOOH), to enhance depolymerization efficiency. Unlike conventional methods, this process leverages an alkaline medium, specifically potassium hydroxide (KOH), under mild conditions. This combination significantly improves hydrolysis efficiency, decreases reaction time, and produces valuable byproducts such as formic acid, terephthalic acid (TPA), and hydrogen gas. Further, unlike conventional methods, the present disclosure can integrate the steps of hydrolysis and electrolysis into a single process using KOH and a nickel electrode, enabling more efficient utilization of resources. Additionally, in certain embodiments, electro-assisted hydrolysis enhances PET conversion to its monomers compared to the conventional process at the same temperature. Such embodiments allow electro-assisted hydrolysis to operate effectively at lower temperatures than conventional hydrolysis, improving energy efficiency.

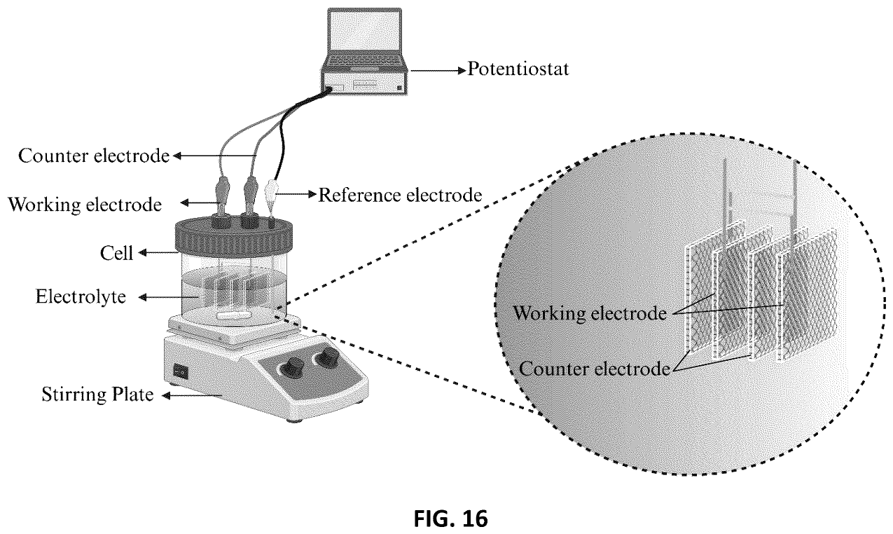

FIG. 16 illustrates the electro-assisted hydrolysis setup, comprising a three-electrode electrochemical cell with a nickel mesh electrode serving as the working electrode. The cell also includes a platinum pseudo-reference electrode and a nickel counter electrode. The plastic slurry, prepared from PET particles and 5M KOH electrolyte, stirs in the electrochemical cell, where a potential between 0.52 V and 0.58 V (vs. Pt reference) is applied. The applied potential promotes the formation of the NiOOH catalyst at the electrode surface, which interacts with the hydrolyzed ethylene glycol (EG) to produce formic acid via electrochemical oxidation.

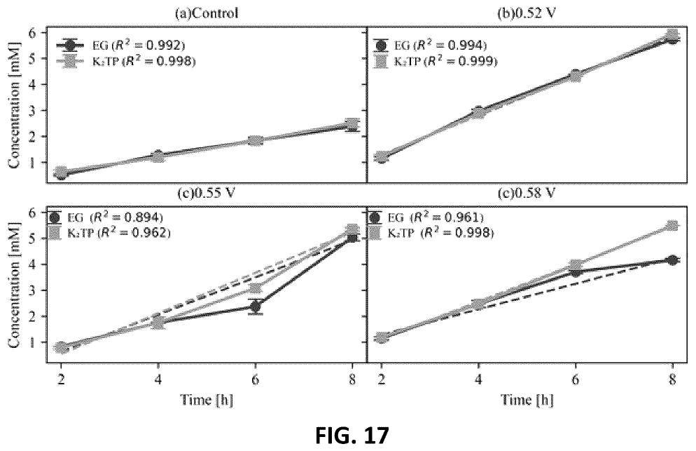

During electro-assisted hydrolysis, the PET undergoes hydrolysis, forming K₂TP and EG as primary products, as depicted in FIG. 17. The applied potential significantly enhances the depolymerization process, achieving up to a two-fold increase in conversion rates compared to non-electrochemical methods. The hydrolysis process is illustrated by the following reactions in Eqs. 3-5, with Eq. 3 (hydrolysis), Eq. 4 (electrochemical oxidation of EG), and Eq. 5 (hydrogen evolution at cathode).

(C₁₀H₈O₄)ₙ+2nKOH→n(C₈H₄O₄K₂)+n(C₂H₆O₂) (3)

C₂H₆O₂+8OH⁻→2HCOO⁻+6H₂O+6e⁻ (4)

6H₂O+6e⁻→3H₂+6OH⁻ (5)

### Enhanced Catalyst Efficiency Using Metal Oxides

Unlike previous methods that primarily use metallic catalysts, the present invention demonstrates that utilizing metal oxide catalysts such as NiOOH (and others such as for example, but not limited to, CuO, Cu₂O, NiO, Fe₂O₃, MnO₂, CoO, CrO, VO, transition metal oxides, and combinations thereof, which are converted into oxyhydroxides in-situ by applying a potential in an alkaline electrolyte) leads to superior catalytic activity and stability. By starting with the metal oxide form, the catalyst activation time is reduced, allowing for better management of the elution time and increasing the overall efficiency of the reaction. The electrochemical formation of NiOOH on the electrode surface further promotes the conversion of ethylene glycol to formic acid, yielding a faradaic efficiency of approximately 53%.

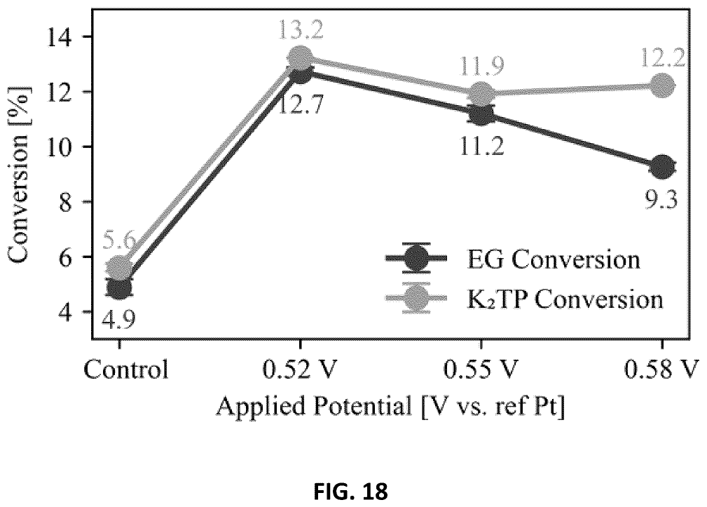

FIG. 18 demonstrates the conversion efficiency of PET depolymerization under various applied potentials, highlighting the optimal potential range of 0.52 V to 0.55 V (vs. Pt reference), which maximizes the conversion of K₂TP and EG while minimizing competing side reactions such as the oxygen evolution reaction (OER).

### Effect of Particle Size on Hydrolysis Efficiency

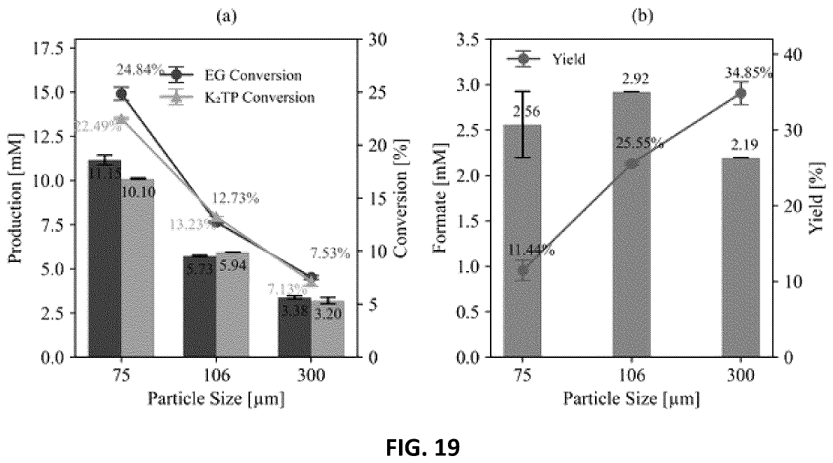

Experimental results indicate that reducing the PET particle size significantly improves conversion efficiency during electro-assisted hydrolysis. FIG. 19 depicts, on the left, the production of EG (blue bars) and K₂TP orange bars) from different PET particle sizes at 0.52V vs ref (Pt), showing an inverse relationship between particle size and both production (left y-axis) and conversion percentage (right y-axis, lines)—smaller particles yield significantly higher monomer production and conversion. FIG. 19 depicts, on the right, formate production (left y-axis, teal bars) and corresponding yield percentages (right y-axis, teal line) across particle sizes, demonstrating opposite trends with yield (increasing with larger particles).

As depicted in FIG. 19, particles with diameters of 75 μm achieve a 24.84% conversion of K₂TP compared to 13.23% for 106 μm particles and 7.13% for 300 μm particles. This trend is attributed to the increased specific surface area, which facilitates more extensive contact between the catalyst and the polymer substrate. The higher surface area enhances the mass transfer of reactants, thereby accelerating the depolymerization rate.

Additionally, the formation of NiOOH at the catalyst surface significantly improves the electrochemical oxidation of EG to formic acid. Particle size optimization is critical for enhancing both hydrolysis and oxidation efficiency, with smaller particles producing significantly higher yields under identical conditions.

The electro-assisted hydrolysis process offers a sustainable alternative to conventional PET recycling by integrating chemical depolymerization with electrochemical oxidation. The generation of valuable products such as TPA, formic acid, and hydrogen gas aligns with the principles of the circular economy by converting plastic waste into reusable raw materials. Moreover, the simultaneous production of hydrogen gas during the cathodic reaction supports clean energy initiatives.

The use of renewable energy sources to power the electrochemical cell, such as solar or wind, further enhances the environmental sustainability of the process. This method not only reduces the carbon footprint associated with plastic waste management but also enables the regeneration of high-purity monomers for polymer synthesis, thus reducing dependency on virgin petrochemical resources.

### Multistage Processes for Plastic Functionalization Using Metal Oxide Catalysts

The present disclosure, in some embodiments, introduces a novel process for the functionalization of polymer backbones through the introduction of functional groups, including C—O, C═C, C═O, and OH bonds. The functionalized polymers produced by this method exhibit versatile applications, particularly in biomedical fields and membrane analytical devices. Additionally, the functionalized polymers can undergo further processing, including electro-Fenton techniques, to generate valuable chemicals such as fatty acids and fuels.

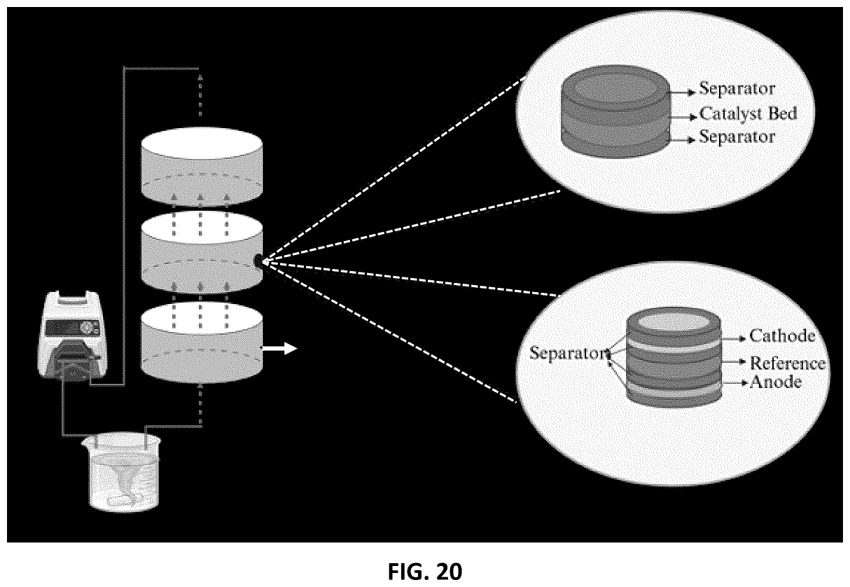

FIG. 20 illustrates a schematic diagram of the process, which implements a multistage packed bed reactor with detailed views of stages containing pre-synthesized catalysts and in-situ generated catalysts. The multistage reactor allows for enhanced control and increased efficiency in polymer functionalization.

In some embodiments, the present disclosure comprises a reactor containing catalysts in single or multiple stages, with separators. In cases where in-situ catalyst generation occurs, the packed bed/stages function as an electrochemical cell containing a cathode, an anode (acting as the catalyst when a potential is applied), and a separator. In some embodiments, the reactor may also include a reference electrode, as shown in FIG. 20.

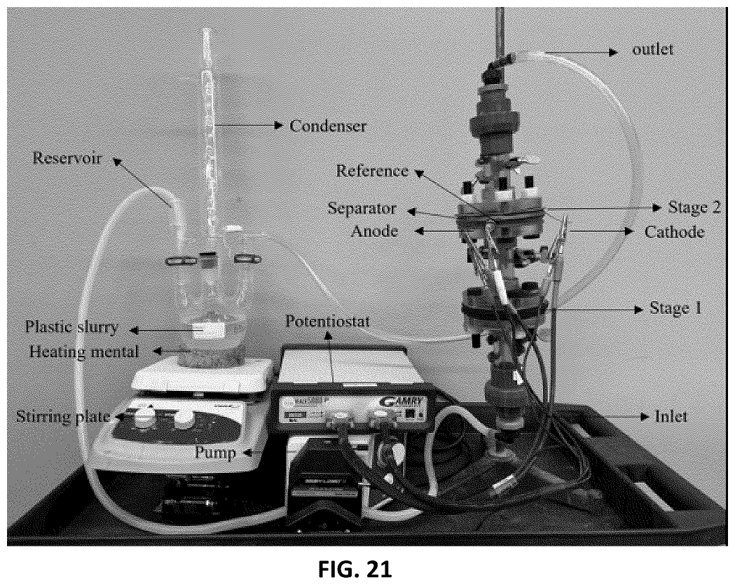

A physical prototype corresponding to the schematic illustrated in FIG. 20 has been constructed to exemplify one embodiment of the disclosed reactor system. The schematic depicted in FIG. 20 was created in BioRender. Botte, G. (2025) https://BioRender.com/8o1f1q1. The schematic in FIG. 20 presents the conceptual design of a multistage packed bed reactor, while the prototype, shown in FIG. 21, reflects the corresponding structural and design elements. Together, these figures illustrate a possible configuration suitable for implementation.

Systems and methods utilizing the present disclosure may further include metal oxide catalysts that can be prepared chemically, electrochemically, or generated in-situ during the process by applying a potential.

In some embodiments, the present disclosure comprises multiple stages within the packed bed reactor, each potentially containing different metal catalysts or metals when using in-situ generated catalysts.

Further, in the same and other embodiments, systems and methods utilizing the present disclosure may include a slurry prepared by mixing ground plastics with a carrier fluid or electrolyte, particularly when using in-situ generated catalysts. From this, the plastic slurry can be pumped from the bottom to the top of the packed bed reactor containing metal oxide particles. Alternative feeding orientations may be optimized based on specific process requirements. Interaction between the plastic slurry and the metal oxides within the reactor can result in the addition of functional groups to the polymer.

Moreover, in some embodiments, the process disclosed herein can include recovery of dissolved catalyst via electrodeposition when necessary, thereby reducing waste and enabling catalyst reuse.

These innovative processes facilitate the functionalization of rigid polymers such as polyethylene and polypropylene, which traditionally lack oxygen groups and are therefore challenging to upcycle. By introducing functional groups without requiring polymer melting, the present invention enables efficient functionalization at moderate temperatures and ambient pressure using aqueous media.

Accordingly, advantages of these processes can include: (1) overcoming major challenges in plastic waste recycling, such as but not limited to, dealing with additives and mixed plastics, (2) breaking C—C bonds of plastic and introducing functional groups without the need of plastic melting, (3) recovery and reuse of catalysts, (4) combination of different metal oxides provides efficient and selective functionalization, and (5) implementation of renewable sources of energy (such as for example, but not limited to, solar, wind) for catalyst generation.

### Multistage Packed Bed Reactor

The present invention provides a multistage packed bed reactor for the functionalization of polymers. The reactor system is designed to facilitate the electrochemical transformation of plastic slurries into functionalized polymers by utilizing metal oxide catalysts. The reactor comprises several key components, including a catalyst bed/anode, a cathode, a separator, a carrier fluid/electrolyte, and, optionally, a reference electrode. The reactor is specifically designed to accommodate the continuous flow of plastic slurries while maintaining efficient contact between the catalyst and the plastic particles.

### Catalyst Bed/Anode

The catalyst bed, which may also serve as the anode in the electrochemical cell, consists of a metal oxide material. The catalyst bed may take the form of a mesh, foam, or other porous structure that permits the passage of the plastic slurry. The design ensures resistance to corrosion based on the characteristics of the carrier fluid and the operational temperature of the system.

In some embodiments, the catalysts within the bed are pre-synthesized chemically or electrochemically by applying a potential prior to the process. Alternatively, the catalysts may be generated in situ during the process through the application of a potential. The applied potential varies according to the specific metal catalyst being utilized.

Suitable metal oxide catalysts include, but are not limited to, oxides of chromium (Cr), manganese (Mn), iron (Fe), cobalt (Co), nickel (Ni), copper (Cu), zinc (Zn), ruthenium (Ru), rhodium (Rh), palladium (Pd), silver (Ag), cadmium (Cd), iridium (Ir), platinum (Pt), gold (Au), vanadium (V), and combinations thereof. In some embodiments, different stages of the packed bed reactor may contain distinct metal oxides, depending on the specific functionalization required.

### Cathode

The cathode in the multistage packed bed reactor is constructed from a conductive material or support. Suitable materials include nickel gauze/mesh, titanium (Ti), stainless steel, Hastelloy, and other conductive materials resistant to corrosion based on the electrolyte, cell voltage, and operational temperature. In some embodiments, the cathode is made of similar anode compositions to implement an oscillation potential to enhance reaction efficiency and conversion.

The cathode may have a perforated, mesh or hollow structure to facilitate fluid flow and contact with the electrolyte. In some configurations, the cathode and anode may be composed of the same material.

Suitable electrocatalysts for the cathode include carbon, graphene, nickel (Ni), iron (Fe), cobalt (Co), molybdenum (Mo), platinum (Pt), rhodium (Rh), ruthenium (Ru), palladium (Pd), iridium (Ir), Copper (Cu), vanadium (V), and combinations thereof.

### Separator

The multistage packed bed reactor may include a separator, particularly when the reactor functions as an electrochemical cell. A suitable separator may include a PTFE gasket or other materials that maintain electrical isolation between the anode and cathode compartments while allowing ionic conductivity.

### Carrier Fluid/Electrolyte, Solvent, and Additives

The carrier fluid or electrolyte used in the packed bed reactor can be an aqueous medium that may include acids, bases, or metal salts. Suitable examples include potassium hydroxide (KOH), sodium hydroxide (NaOH), sulfuric acid (H₂SO₄), copper sulfate (CuSO₄), and nickel sulfate (NiSO₄), with concentrations ranging from 0.1 M to 5 M, depending on the chosen carrier fluid or electrolyte.

The electrolyte may also contain surfactants or organic solvents to enhance plastic dispersion. Examples of suitable organic solvents include methanol, ethanol, isopropanol, and acetone. Additionally, the electrolyte may include additives such as lactic acid or ethylenediaminetetraacetic acid (EDTA) to improve catalytic performance or slurry stability.

### Reference Electrode

In some embodiments, the potential applied to the reactor may be controlled with respect to a reference or pseudo-reference electrode. Suitable reference electrodes include platinum (Pt), nickel (Ni), gold (Au), silver chloride (Ag/AgCl), silver (Ag), or mercury/mercury oxide (Hg/HgO). The use of a reference electrode allows precise control of the electrochemical conditions within the reactor.

### Method

The process for functionalizing plastic slurries using the multistage packed bed reactor includes the following steps. The plastic slurry is pumped through the packed bed reactor using a pump. The flow rate is controlled to ensure efficient contact between the slurry and the catalyst. When in-situ catalyst generation is required, a potential is applied to produce the respective metal oxide catalysts within the reactor. The reactor temperature can be maintained within the range of 20° C. to 130° C. to optimize reaction kinetics while preventing thermal degradation of the catalyst. If the catalyst dissolves in the carrier fluid or solvent, electrodeposition is performed to recover the metal onto a cathode within the electrochemical cell.

In certain embodiments, the slurry can be prepared as a mixture of plastics and/or polymers with the carrier fluid. The particle size of the plastics can range from approximately 10 microns to 2000 microns. In some cases, the plastic particles may be sieved to achieve a uniform size distribution, promoting consistent reaction kinetics.

The potential applied during the process is determined based on the specific reference electrode and the metal catalyst being utilized. The applied potential is typically calculated as the thermodynamic potential of the metal oxide formation plus an overpotential of at least 200 mV.

If a reference electrode is not used, the cell voltage (measured between anode and cathode) is applied directly. In this configuration, the process is optimized using a reference electrode to determine the optimum cell voltage based on factors such as flow rate, plastic concentration, particle size, electrolyte composition, electrocatalyst, and temperature.

In some embodiments, a pulsed potential may be applied to optimize catalyst generation and polymer functionalization. Pulsing may enhance the stability of the catalyst and improve the efficiency of the functionalization process.

The process temperature is controlled within the range of 20° C. to 130° C., depending on the specific reaction requirements. Maintaining an appropriate temperature ensures efficient catalytic activity while minimizing potential catalyst deactivation or polymer degradation.

In situations where the catalyst dissolves into the carrier fluid or solvent during the process, electrodeposition is employed to recover the catalyst. The metal is deposited onto the respective electrode, typically the cathode, using an applied potential that facilitates the reformation of the metal oxide. This recovery method reduces waste, maintains catalyst efficiency, and ensures process sustainability.

Two experiments were conducted to functionalize low-density polyethylene (LDPE) particles having an average size of approximately 500 microns. The LDPE particles, supplied by Alfa Aesar (ACS #9002-88-4), have a melting point of approximately 120° C. and a density of 0.9220 g/mL. To achieve a uniform size distribution, the LDPE particles were ground and subsequently sieved to obtain homogenous particles with a size of 106 microns. The experiments were performed in a 100 mL electrochemical cell containing copper sheets as electrodes, with the reaction medium consisting of 50 mL of 5 M potassium hydroxide (KOH) at 90° C. The mass of LDPE used was 0.5 g, and the reaction duration was maintained at 62 hours.

In the first experiment, a pseudo platinum reference electrode and two copper sheets were utilized as the working and counter electrodes. An oscillating potential ranging between −0.45 V and −0.25 V versus the pseudo platinum reference electrode was applied. The potential applied is required to create the oxyhydroxide catalyst and this value maybe affected by cell resistance, temperature, distance between anode and cathode, and plastic slurry concentration. The polarity of the applied potential was switched every 10 seconds throughout the 62-hour reaction period. An identical experiment was performed without applying any potential, which is hereinafter referred to as the “chemical experiment.”

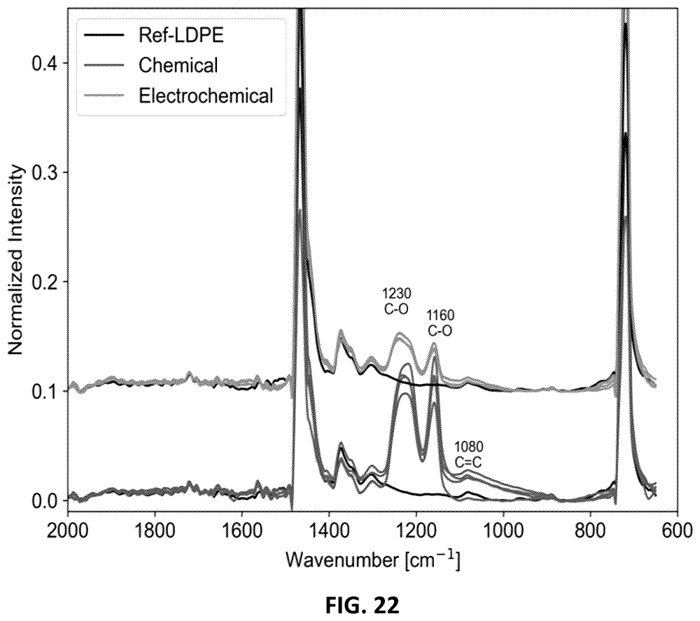

FIG. 22 illustrates the Fourier Transform Infrared (FTIR) analysis of the LDPE samples after both the chemical and electrochemical experiments. As shown in FIG. 22, the results of both experiments demonstrated successful functionalization of the LDPE, with the introduction of C═C and C—O bonds. Notably, the chemical experiment exhibited a greater intensity of these functional groups in comparison to the electrochemical experiment, indicating that the chemical process was more efficient in generating the desired functional groups under the tested conditions.

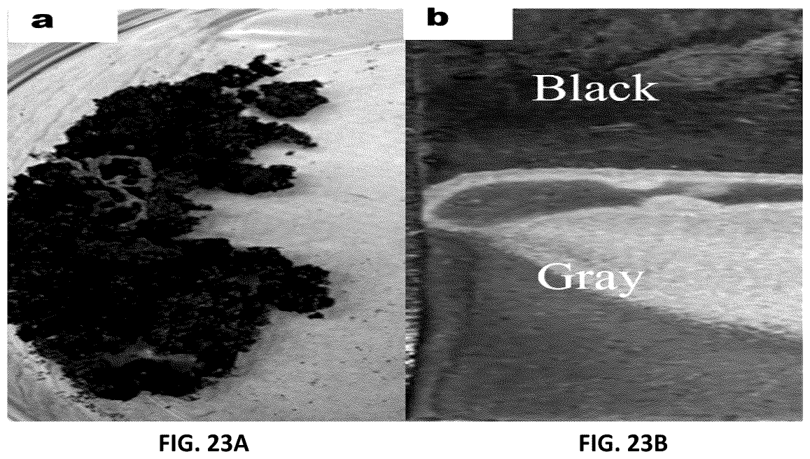

At the conclusion of both the chemical and electrochemical experiments, the polymer exhibited aggregation with the formation of a black residue, as depicted in FIG. 23A. FIG. 23A shows the physical appearance of the agglomerated polymer with the black residue, which was identified as a potential catalytic by-product. The residue was generated as a result of a chemical reaction between the copper sheet, potassium hydroxide, and the elevated temperature during the experiment.

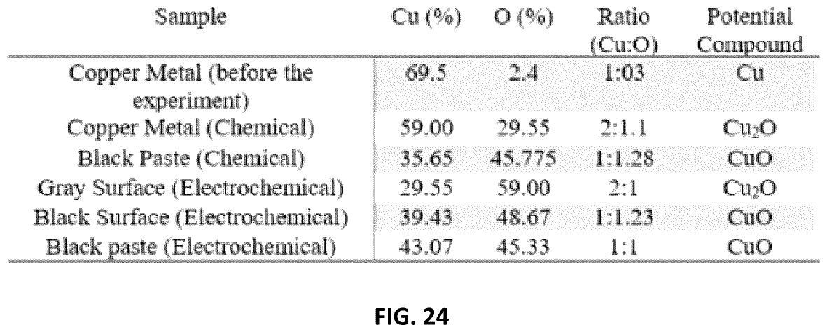

The copper metal sheet used in the chemical experiment, as well as the black paste, were analyzed via energy-dispersive X-ray spectroscopy (EDX). FIG. 24 presents the EDX analysis of the copper sheet and the black paste after the treatment. As shown in FIG. 24, the results confirmed the formation of Cu₂O on the copper metal and CuO within the black paste. Specifically, the data showed that the copper metal surface prior to the experiment contained approximately 69.5% copper and 2.4% oxygen, while after the chemical experiment, the copper metal exhibited 59.00% copper and 29.55% oxygen, consistent with the formation of Cu₂O. The black paste revealed a higher oxygen content, indicating the formation of CuO. It is reported that during hydrothermal oxidation, copper initially forms a Cu₂O layer, which subsequently transforms into a more fragile CuO layer.

During the electrochemical experiment, the switching potential caused the formation of Cu²⁺ and Cu⁺ species, which were deposited again onto the electrode surface. At the conclusion of the reaction, the electrode exhibited two distinct color regions: gray and black, as illustrated in FIG. 23B. FIG. 23B shows the electrode surface after the electrochemical treatment, with the gray area corresponding to Cu₂O and the black area to CuO. The weight loss of the copper sheet in the chemical experiment indicated a higher catalyst-to-polymer ratio, which correlated with the more pronounced intensity observed in the FTIR spectrum. These results indicate that metal oxide species can be generated both chemically and electrochemically (via applied potential), facilitating the functionalization of plastics.

The functionalization potential of different metal oxides, specifically CuO and Cu₂O, was subsequently investigated. To this end, CuO and Cu₂O were mixed with LDPE and processed within a digester at 90° C. for a period of 62 hours. The CuO powders used in these experiments were synthesized chemically as described previously, while Cu₂O was obtained from a commercial source. Following the reaction, all samples were washed with 1 M sulfuric acid and subsequently rinsed with deionized water. The washed samples were then dried in a vacuum oven to remove residual moisture.

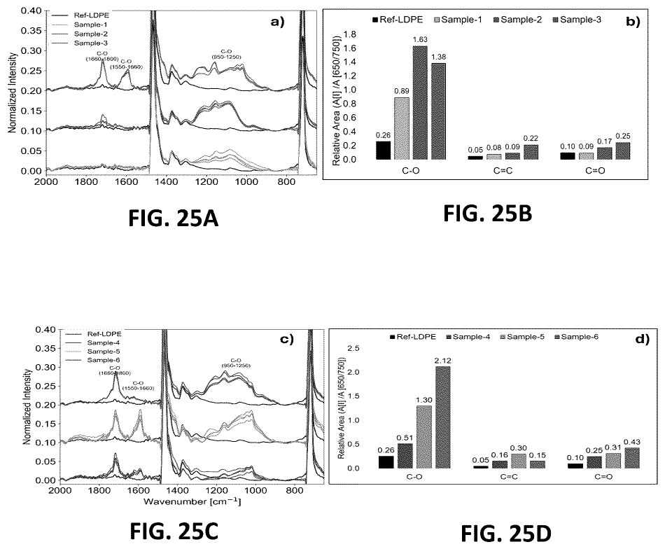

FIGS. 25A-25D show the experimental setup and results of the functionalization process using CuO and Cu₂O catalysts. FIG. 25A and FIG. 25C display the functionalization of LDPE with CuO and Cu₂O catalysts, respectively, while FIG. 25B and FIG. 25D depict the corresponding FTIR quantification of the functional groups formed. The analysis demonstrates distinct catalytic roles of CuO and Cu₂O in the functionalization of LDPE. CuO primarily enhances the C—O region (950-1250 cm⁻¹), as evidenced by the increased C—O index of 0.89 observed in Sample 1. In contrast, Cu₂O not only enhances the C—O region but also promotes the formation of C═C (1550-1650 cm⁻¹) and C═O (1650-1800 cm⁻¹) bonds, as observed in Sample 3, where the C—O index increased to 1.38.

Moreover, as shown in FIGS. 25C and 25D, Sample 5 further demonstrated Cu₂O's ability to double the C═C intensity and slightly increase C═O bonds. compared to Sample 4, which was only mixed with Cu₂O. In Sample 6, CuO effectively doubled the C—O index but had minimal impact on the C═C region, indicating its specificity toward C—O bond formation.

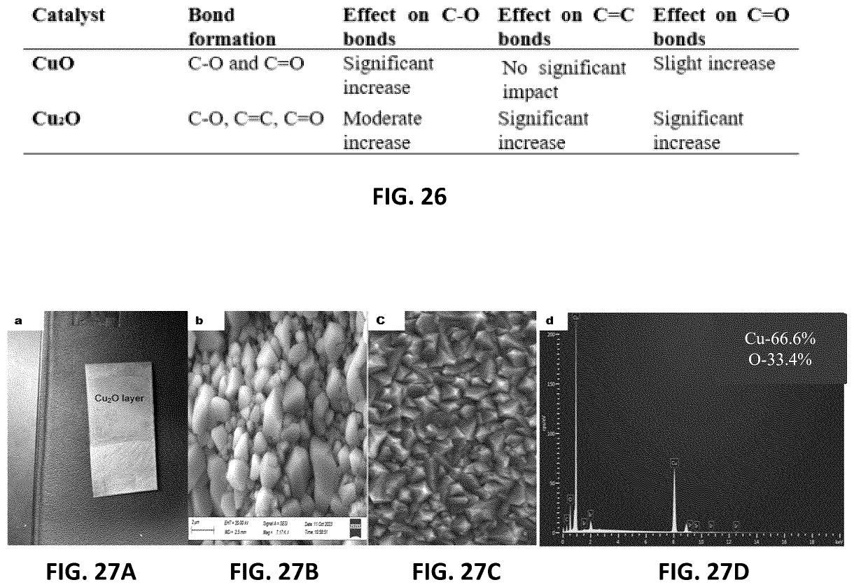

FIG. 26 summarizes the catalytic roles of CuO and Cu₂O in LDPE functionalization, showing that CuO is more selective toward C—O bond formation, whereas Cu₂O effectively facilitates both C═C and C═O bond formations. These complementary catalytic characteristics highlight the potential of combining different metal oxide catalysts for selective and efficient functionalization of plastics.

An electrochemical approach was also employed to generate Cu₂O on a titanium substrate. Cyclic voltammetry was performed using a clean titanium electrode as the working electrode within a 5 mM CuSO₄ solution. The potential was cycled between 0 and −0.2 V for 20 cycles. A thin brown layer formed on the surface, identified as Cu₂O through EDX and scanning electron microscopy (SEM) analysis. FIG. 27A shows the formation of the Cu₂O layer on the titanium electrode. FIG. 27B depicts the SEM image revealing the crystalline structure of Cu₂O. FIG. 27C presents a comparison with the known crystalline framework of Cu₂O from literature, confirming the structure. FIG. 27D illustrates the EDS imaging results, showing a 2:1 ratio of copper to oxygen, consistent with the composition of Cu₂O.

These results demonstrate the viability of electrochemical methods for generating metal oxide catalysts with precise structural control, thereby enhancing their applicability for selective plastic functionalization. The demonstrated ability to generate and utilize metal oxide catalysts, either chemically or electrochemically, provides a versatile approach to polymer functionalization. The selection of specific metal oxides, such as CuO or Cu₂O, enables targeted functional group formation, thereby optimizing the upcycling of plastic waste into value-added chemical products. The integration of these catalytic systems within a multistage packed bed reactor offers a scalable and efficient method for sustainable plastic upcycling.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

### REFERENCES

Abedsoltan, H., A focused review on recycling and hydrolysis techniques of polyethylene terephthalate, Polym. Eng. Sci. 63(9) (2023) 2651-2674.
Abusrafa, A. E., et al., “Modification Of Polyethylene By RF Plasma In Different/Mixture Gases,” Coatings, 2019, 9, 145 (“Abusrafa 2019”)
Agostini, I. et al., B. Ciuffi, R. Gallorini, A. M. Rizzo, D. Chiaramonti, L. Rosi, Recovery of Terephthalic Acid from Densified Post-consumer Plastic Mix by HTL Process, Molecules 27(20) (2022) 7112.
Ait Hssi, A.; Atourki, L.; Labchir, N.; Ouafi, M.; Abouabassi, K.; Elfanaoui, A.; Ihlal, A.; Benmokhtar, S.; Bouabid, K. High-quality Cu₂O thin films via electrochemical synthesis under a variable applied potential. Journal of Materials Science: Materials in Electronics 2020, 31 (5), 4237-4244 (“Ait Hssi 2020”).
Allara, D. L. et al., “Mechanism Of Oxidation At A Copper-Polyethylene Interface. II. Penetration Of Copper Ions In The Polyethylene Matrix,” Journal of Polymer Science: Polymer Chemistry Edition, 1976, 14, 93-104 (“Allara 1976”).
Balaji, S., et al., “Cerium(IV)-Mediated Electrochemical Oxidation Process For Destruction Of Organic Pollutants In A Batch And A Continuous Flow Reactor,” Korean Journal of Chemical Engineering, 2007, 24, 1009-1016 (“Balaji 2007”).
Banu, A. et al., Formic acid production through electrochemical reduction of CO2: A life cycle assessment, Energy Convers. Manag. X 20 (2023) 100441 (“Banu 2023”).
Barakat, N. A. M. et al., New electrooxidation characteristic for Ni-based electrodes for wide application in methanol fuel cells, Appl. Catal. A Gen. 555 (2018) 148-154 (“Barakat 2018”).
Behera, S. et al., Quantitative Electrocatalytic Upcycling of Polyethylene Terephthalate Plastic and Its Oligomer with a Cobalt-Based One-Dimensional Coordination Polymer Having Open Metal Sites along with Coproduction of Hydrogen, ACS Catal. 13(1) (2023) 469-474 (“Behera 2023”).
Bokare, A. D., et al., “Review Of Iron-Free Fenton-Like Systems For Activating H₂O₂ In Advanced Oxidation Processes,” Journal of Hazardous Materials, 2014, 275, 121-135 (“Bokare 2014”).
Brewis, D. M., et al., “A ToF-SIMS Study Of Electrochemical Pretreatments For Polymers,” Surface and Interface Analysis, 2000, 29, 572-581 (“Brewis 2000”).
Brillas, E., et al., “Electro-Fenton Process And Related Electrochemical Technologies Based On Fenton's Reaction Chemistry,” Chemical Reviews, 2009, 109, 6570-6631 (“Brillas 2009”).
Canada Patent Appl. No. CA2267045, “Electrochemical hydrogenolysis of Lignins on Raney Nickel Based Cathodes,” filed Aug. 2, 2011, to Paul, J. (“Paul '945 patent application”).
Carta, D. et al., Chemical recycling of poly(ethylene terephthalate) (pet) by hydrolysis and glycolysis, Environ. Sci. Pollut. Res. 10(6) (2003) 390-394 (“Carta 2003”).
Castrejón-Sánchez, V.-H.; Solis, A. C.; López, R.; Encarnación-Gomez, C.; Morales, F. M.; Vargas, O. S.; Mastache-Mastache, J. E.; Sinchez, G. V. Thermal oxidation of copper over a broad temperature range: towards the formation of cupric oxide (CuO). Materials Research Express 2019, 6 (7), 075909 (“Castrejón-Sdnchez 2019”).
Celik, G., et al., “Upcycling Single-Use Polyethylene into High-Quality Liquid Products,” ACS Central Science, 2019, 5 (11), 1795-1803 (“Celik 2019”).
Celik, G.; Kennedy, R. M.; Hackler, R. A.; Ferrandon, M.; Tennakoon, A.; Patnaik, S.; LaPointe, A. M.; Ammal, S. C.; Heyden, A.; Perras, F. A.; et al. Upcycling Single-Use Polyethylene into High-Quality Liquid Products. ACS Central Science 2019, 5 (11), 1795-1803 (“Celik 2019”).
Chabira, S. F., et al., “Oxidation And Crosslinking Processes During Thermal Aging Of Low-Density Polyethylene Films,” Journal of Applied Polymer Science, 2012, 124, 5200-5208 (“Chabira 2012”).
Chan, M. G.; Allara, D. L. Infrared reflection studies of the mechanism of oxidation at a copper-polyethylene interface. Journal of Colloid and Interface Science 1974, 47 (3), 697-704 (“Chan 1974”).
Chemanalyst, Formic Acid Market Analysis Report. https://www.chemanalyst.com/industry-report/formic-acid-market-688, 2023, (Last accessed 5 Jan. 2025) (“Chemanalyst”).
ChemicalBook, 1H NMR Spectrum of Glycolic Acid. https://www.chemicalbook.com/SpectrumEN_79-14-1_lhnmr.htm, n.d., (Accessed 10 Jan. 2025) (“ChemicalBook”).
Chiba, Z., et al., Mediated Electrochemical Oxidation Treatment for Rocky Flats Combustible Low-Level Mixed Waste, Report UCRL-ID-118679, California, 1994 (“Chiba 1994”).
Chinese Patent No. CN102277591, “Method for Electrochemically Degrading Lignin,” issued Mar. 5, 2014, to Pingyu, W., et al. (“Pingyu '591 patent”).
Chow, C. F., et al., “Combined Chemical Activation And Fenton Degradation To Convert Waste Polyethylene Into High-Value Fine Chemicals,” Chemistry—A European Journal, 2016, 22, 9513-9518 (“Chow 2016”).
Chow, C.-F.; Wong, W.-L.; Ho, K. Y.-F.; Chan, C.-S.; Gong, C.-B. Combined Chemical Activation and Fenton Degradation to Convert Waste Polyethylene into High-Value Fine Chemicals. Chemistry—A European Journal 2016, 22 (28), 9513-9518 (“Chow 2016”).
Chumakov, A., et al., “Electro-Fenton-Like Reactions Of Transition Metal Ions With Electrogenerated Hydrogen Peroxide,” AIP Conference Proceedings, 2016, 1772, 040004 (“Chumakov 2016”).
Cudennec, Y.; Lecerf, A. The transformation of Cu(OH)2 into CuO, revisited. Solid State Sciences 2003, 5 (11), 1471-1474 (“Cudennec 2003”).
Das, P., et al., “Thermal Degradation Kinetics Of Plastics And Model Selection,” Thermochimica Acta, 2017, 654, 191-202 (“Das 2017”).
Deng(s), Y. L. C., Process for producing formic acid by acidifying sodium formate with acidifying agent, WO2009026773A1, 2009 (“Deng 2009”).
Despid, A. R., Draić, D. M., Mihailović, M. L., Lorenc, L. L., Adić, R., Ivić, M., Non-faradaic electrocatalysis: Part I. Acceleration of ester hydrolysis in the electrochemical double layer, J. Electroanal. Chem. 100(1) (1979) 913-925 (“Despic 1979”).
Feng, X. et al., Sustainable solar- and electro-driven production of high concentration H2O2 coupled to electrocatalytic upcycling of polyethylene terephthalate plastic waste, Chem. Eng. J. 482 (2024) 149191 (“Feng 2024”).
Geyer, R., et al., “Production, Use, And Fate Of All Plastics Ever Made,” Sci Adv, 2017, 3, 7, e10700782 (“Geyer 2019”).
Geyer, R.; Jambeck, J. R.; Law, K. L. Production, use, and fate of all plastics ever made. Science Advances 2017, 3 (7), e1700782 (“Geyer 2017”).
Gomollón-Bel, F., “New Family Of Polymers Can Be Easily Recycled And Even Upcycled,” Chemistry World, 2019, https://www.chemistryworld.com/news/new-family-of-polymers-can-be-easily-recycled-and-even-upcycled/3010439.article (“Gomollón-Bel 2019”).
Gulmine, J. V., et al., “Polyethylene Characterization By FTIR,” Polymer Testing, 2002, 21, 557-563 (“Gulmine 2002”).
Hadjiivanov, K., “Identification and Characterization Of Surface Hydroxyl Groups By Infrared Spectroscopy,” Advances in Catalysis, ed. F. C. Jentoft, Academic Press, 2014, vol. 57, pp. 99-318 (“Hadjiivanov 2014”).
Hamzah, M., et al., “Surface Chemistry Changes And Microstructure Evaluation Of Low Density Nanocluster Polyethylene Under Natural Weathering: A Spectroscopic Investigation,” Journal of Physics: Conference Series, 2018, 984, 012010 (“Hamzah 2018”).
Hassan, Q. et al., Green hydrogen: A pathway to a sustainable energy future, Int. J. Hydrogen Energy 50 (2024) 310-333 (“Hassan 2024”).
Hori, T., et al., “Fuel Cell And Electrolyzer Using Plastic Waste Directly As Fuel,” Waste Management, 2020, 102, 30-39 (“Hori 2020”).
Jin X., et al., “Understanding The Kinetics Of Coal Electrolysis At Intermediate Temperatures,” Journal of Power Sources, 2010, 195, 4935-4942 (“Jin 2010”).
Jud, W. et al., Electrochemical Oxidation of Alcohols Using Nickel Oxide Hydroxide as Heterogeneous Electrocatalyst in Batch and Continuous Flow, Org. Process Res. Dev. 26(5) (2022) 1486-1495 (“Jud 2022”).
Kärkäs, M. D., “Electrochemical Strategies For C—H Functionalization And C—N Bond Formation,” Chemical Society Reviews, 2018, 47, 5786-5865 (“Kdrkds 2018”).
Kilaparthi, S. K. et al., Simultaneous upcycling of PET plastic waste and CO2 reduction through Co-electrolysis: a novel approach for integrating CO2 reduction and PET hydrolysate oxidation, J. Mater. Chem. A 11(47) (2023) 26075-26085 (“Kilaparthi 2023”).
Kim, N. et al., High production of CH4 and H2 by reducing PET waste water using a non-diaphragm-based electrochemical method, Sci. Rep. 6(1) (2016) 20512 (“Kim 2016”).
Lens, J. P., at al., “Introduction Of Carboxylate Groups At Poly(Ethylene) Surfaces By Argon Plasma Immobilization Of Sodium Salts Of Fatty Acids,” Langmuir, 1997, 13, 7052-7062 (“Lens 1997”).
Li, M. et al., Tandem Chemical Depolymerization and Photoreforming of Waste PET Plastic to High-Value-Added Chemicals, ACS Catal. 14(5) (2024) 2949-2958 (“Li 2024”).
Li, X. et al., Photoelectrochemical Catalysis of Waste Polyethylene Terephthalate Plastic to Coproduce Formic Acid and Hydrogen, ACS sustainable chem. eng. 10(29) (2022) 9546-9552 (“Li 2022”).
Li, Y. et al., Alcohol-alkali hydrolysis for high-throughput PET waste electroreforming-assisted green hydrogen generation, J. Mater. Chem. A 12(4) (2024) 2121-2128 (“Li 2024”).
Li, Z. F., et al., “Revisiting The Electrochemical Oxidation Of Ammonia On Carbon-Supported Metal Nanoparticle Catalysts,” Electrochimica Acta, 2017, 228, 351-360 (“Li 2017”).
Lin, Q. et al., Electrocatalytic oxidation of ethylene glycol and glycerol on nickel ion implanted-modified indium tin oxide electrode, Int. J. Hydrogen Energy 42(2) (2017) 1403-1411 (“Lin 2017”).
Liu, C., Yang, F., Schechter, A., Feng, L., Recent progress of Ni-based catalysts for methanol electrooxidation reaction in alkaline media, Adv. Sensor Energy Mater. 2(2) (2023) 100055 (“Liu 2023”).
Liu, K., Wang, Y., Liu, F., Liu, C., Shi, R., Chen, Y., Selective electrocatalytic reforming of PET-derived ethylene glycol to formate with a Faraday efficiency of 93.2% at industrial-level current densities, Chem. Eng. J. 473 (2023) 145292 (“Liu 2023”).
Liu, S., et al., “Water-Ionomer Interfacial Interactions Investigated By Infrared Spectroscopy And Computational Methods,” Langmuir, 2013, 29, 13890-13897 (“Liu 2013”).
Lu, F., Botte, G. G., Understanding the Electrochemically Induced Conversion of Urea to Ammonia Using Nickel Based Catalysts, Electrochim. Acta 246 (2017) 564-571. (“Lu 2017”).
Mao, Y. et al., Trash to treasure: electrocatalytic upcycling of polyethylene terephthalate (PET) microplastic to value-added products by Mn0.1Ni0.9Co2O4−δ RSFs spinel, J. Hazard. Mater. 457 (2023) 131743 (“Mao 2023”).
Martinez-Colunga, J. G., et al., “Effect Of Ultrasonic Irradiation On Low-Density Polyethylene Molecular Structure,” Polymer Bulletin, 2020, 77, 5303-5321 (“Martinez-Colunga 2020”).
Masoud, M. S., et al., “Synthesis And Characterization Of Some Transition Metals Polymer Complexes,” Journal of Molecular Structure, 2015, 1095, 135-143 (“Masoud 2015”).
Mishra, S. et al., Chemical Recycling, Kinetics, and Thermodynamics of Poly (Ethylene Terephthalate) (PET) Waste Powder by Nitric Acid Hydrolysis, Polym. React. Eng. 11(1) (2003) 79-99 (“Mishra 2003”).
Möhle, S., et al., “Modern Electrochemical Aspects For The Synthesis Of Value-Added Organic Products,” Angewandte Chemie International Edition, 2018, 57, 6018-6041 (“Möhle 2018”).
Moore, F. G., et al., “Integration Or Segregation: How Do Molecules Behave At Oil/Water Interfaces?” Accounts of Chemical Research, 2008, 41, 739-748 (“Moore 2008”).
Noritake, A. et al., Recycling of Polyethylene Terephthalate Using High-pressure Steam Treatment, Polym. J. 40(6) (2008) 498-502 (“Noritake 2008”).
Palhano, Z. Tânia Marina et al., Chemical Recycling of Poly(ethylene terephthalate) (PET) by Alkaline Hydrolysis and Catalyzed Glycolysis, Orbital Electron. J. Chem. 10(3) (2018) (“Palhano 2018”).
Parthasarathy, V.; Dhanalakshmi, V.; Anbarasan, R. Functionalization of Low Density Polyethylene with Ethyl Crotonate and Ethyl Salicylate in the Presence of Free Radical Initiator: FTIR-RI Kinetics Study. Asian Journal of Chemistry 2013, 25 (7), 3755-3761. DOI: 10.14233/ajchem.2013.13748 (accessed 2024/12/11) (“Parthasarathy 2013”).
Phan, V. et al., Elucidating Pathways of Methanol Oxidation on Oxygen-Vacant NiOOH Sites Using a Synergistic in Situ Attenuated Total Reflectance Surface-Enhanced Infrared Absorption Spectroscopy and DFT Study, ECS Meet. Abstr. MA2024-01 (2024) 2406-2406 (“Phan 2024”).
Quezado, S., et al., “An Infrared Study Of Water-Ion Interactions In Perfluorosulfonate (Nafion) Membranes,” Can J Chem, 1984, 62, 958-96 (“Quezado 1984”).
Rafiee, M., et al., “Electrochemical Aminoxyl-Mediated Oxidation Of Primary Alcohols In Lignin To Carboxylic Acids: Polymer Modification And Depolymerization,” Journal of the American Chemical Society, 2019, 141, 15266-15276 (“Rafiee 2019”).
Rahimzadeh, R.; Ortega-Ramos, J.; Haque, Z.; Botte, G. G. Electrochemical Oxidation and Functionalization of Low-Density Polyethylene. ChemElectroChem 2023, 10 (10), e202300021 (“Rahimzadeh 2023”).
Ringuette, A. E.; Aktas Eken, G.; Garnenez, A. B.; Palmieri, A. I.; Ober, C. K.; Coates, G. W.; Fors, B. P. Direct Functionalization of Polyethylene Surfaces with High-Density Polymer Brushes. Journal of the American Chemical Society 2024, 146 (30), 20563-20568 (“Ringuette 2024”).
Ritter, H. Functionalized polymers: synthesis and properties. Beilstein Journal of Organic Chemistry 2010, 6, 55 (“Ritter 2010”).
Robertson, D., et al., “Degradation Of Polyethylene Geomembranes (GBR-P) Used In Road Tunnels,” 10th International Conference on Geosynthetics, Berlin, 2014, 800 (“Robertson 2014”).
Rocha, M. et al., “Characterization And Accelerated Ageing of UHMWPE Used In Orthopedic Prosthesis by Peroxide,” Materials (Basel), 2009, 2, 562-576 (“Rocha 2009”).
Ruvolo-Filho, A., et al., “Correlation Between Onset Oxidation Temperature (OOT) And Fourier Transform Infrared Spectroscopy (FTIR) For Monitoring The Restabilization Of Recycled Low-Density Polyethylene (LDPE),” Polímeros, 2013, 23, 614-618 (“Ruvolo-Filho 2013”).
Sack, S.; Schär, S.; Steger, E.; Wagner, H. Studies on the mechanism of the copper-catalyzed thermal oxidation of low-density polyethylene. Polymer Degradation and Stability 1984, 7 (4), 193-203 (“Sack 1984”).
Shao, Y. et al., Temperature effects on the ionic conductivity in concentrated alkaline electrolyte solutions, Phys. Chem. Chem. Phys. 22(19) (2020) 10426-10430 (“Shao 2020”).
Shi, R. et al., Electrocatalytic reforming of waste plastics into high value-added chemicals and hydrogen fuel, Chem. Commun. 57(94) (2021) 12595-12598 (“Shi 2021”).
Sibeko, M. A., et al., “Preparation And Characterisation Of Vinylsilane Crosslinked Low-Density Polyethylene Composites Filled With Nano Clays,” Polymer Bulletin, 2014, 71, 637-657 (“Sibeko 2014”).
Siddiqa, A. J.; Chaudhury, K.; Adhikari, B. Hydrophilic Low Density Polyethylene (LDPE) Films for Cell Adhesion and Proliferation. 2015 (“Siddiga 2015”).
Silverstein, Robert M. et al., Spectrometric Identification of Organic Compounds, 8th ed., Hoboken, New Jersey, 2014 (“Silverstein 2014”).
Smith, B., Infrared Spectroscopy of Polymers, VIII: Polyesters and the Rule of Three, Spectrosc. (2022) 25-28 (“Smith 2022”).
Song, J., et al., A review on fundamentals for designing oxygen evolution electrocatalysts, Chem. Soc. Rev. 49(7) (2020) 2196-2214 (“Song 2020”).
Song, X., et al., “Water Vapor Adsorption On Goethite,” Environmental Science & Technology, 2013, 47, 7171-7177 (“Song 2013”).
Sugiura, M., et al., “Distribution Analysis Of Hydroxyl Groups In Polymers By Derivatization-Electron Probe X-Ray Microanalysis,” Analytical Sciences, 2000, 16, 1313-1316 (“Sugiura 2000”).
ThermoFisher Scientific, Polyethylene Powder. Product Specification, available online https://www.alfa.com/en/prodspec/A10239 (accessed March 2020) (“ThermoFisher 2020”).
Tofa, T. S., et al., “Enhanced Visible Light Photodegradation Of Microplastic Fragments With Plasmonic Platinum/Zinc Oxide Nanorod Photocatalysts,” Catalysts, 2019, 9, 819 (“Tofa 2019”).
Torreilles, J., et al., “Nickel (II) As A Temporary Catalyst For Hydroxyl Radical Generation,” FEBS Letters, 1990, 272, 58-60 (“Torreilles 1990”).
Treimer, S. E., et al., “Comparison Of Voltammetric Responses Of Toluene And Xylenes At Iron(III)-Doped, Bismuth(V)-Doped, And Undoped β-Lead Dioxide Film Electrodes In 0.50 M H₂SO₄,” Journal of The Electrochemical Society, 2001, 148, E459 (“Treimer 2001”).
U.S. Pat. No. 9,200,207, “Methods of Producing Liquid Hydrocarbon Fuels from Solid Plastic Wastes,” issued Dec. 1, 2015, to Huang, C., et al. (“Huang '207 patent”).
UNEP Single-Use Plastics: A Roadmap for Sustainability; ISBN: 978-92-807-3705-9; 2018 (“UNEP 2018”).
USDOE Rountable on Chemical Upcycling of Polymers; US, Department of Energy. Office of Science: 2019 (“USDOE 2019”).
Vedharathinam, V. Botte, G. G., Understanding the electro-catalytic oxidation mechanism of urea on nickel electrodes in alkaline medium, Electrochim. Acta 81 (2012) 292-300 (“Vedharathinam 2012”).
Wan, B. et al., Kinetics of Depolymerization of Poly(ethylene terephthalate) in a Potassium Hydroxide Solution, Ind. Eng. Chem. Res. 40(2) (2001) 509-514 (“Wan 2001”).
Wang, H., et al., “Surface Treatment Of LLDPE And LDPE Blends By Nitric Acid, Sulfuric Acid, And Chromic Acid Etching,” Colloid and Polymer Science, 2009, 287, 541-548 (“Wang 2009”).
Wang, J. et al., Electrocatalytic Valorization of Poly(ethylene terephthalate) Plastic and CO2 for Simultaneous Production of Formic Acid, ACS Catal. 12(11) (2022) 6722-6728.
Wang, X.-L., et al., Rapid hydrolysis of PET in high-concentration alcohol aqueous solution by pore formation and spontaneous separation of terephthalate, J. Environ. Chem. Eng. 11(2) (2023) 109434 (“Wang 2023”).
Yagoubi, W., et al., “Identification Of Carbonyl Species Of Weathered LDPE Films By Curve Fitting And Derivative Analysis Of IR Spectra,” Polymer Testing, 2015, 44, 37-48 (“Yagoubi 2015”).
Yoshioka, T. et al., Kinetics of Hydrolysis of Poly(ethylene terephthalate) Powder in Sulfuric Acid by a Modified Shrinking-Core Model, Ind. Eng. Chem. Res. 40(1) (2001) 75-79 (“Yoshioka 2001”).
Źenkiewicz, M., et al., “Comparison Of Some Oxidation Effects In Polyethylene Film Irradiated With Electron Beam Or Gamma Rays,” Radiation Physics and Chemistry, 2003, 68, 799-809 (“Źenkiewicz 2003”).
Zhao, S.; Zhou, C.; Zan, R.; Shu, M.; Suo, T.; Xin, Z. Preparation of effective antibacterial composites of low-density polyethylene modified with quaternary ammonium functionalized zinc oxide nanoparticles. Journal of Polymer Research 2024, 31 (9), 262 (“Zhao 2024”).
Zhong, Y., et al., “The Constraints Of Transition Metal Substitutions (Ti, Cr, Mn, Co And Ni) In Magnetite On Its Catalytic Activity In Heterogeneous Fenton And UV/Fenton Reaction: From The Perspective Of Hydroxyl Radical Generation,” Applied Catalysis B: Environmental, 2014, 150-151, 612-618 (“Zhong 2014”).
Zhou, H. et al., Electrocatalytic upcycling of polyethylene terephthalate to commodity chemicals and H2 fuel, Nat. Commun. 12(1) (2021) 4679 (“Zhou 2021”).
Zhu, B. et al., Unraveling a bifunctional mechanism for methanol-to-formate electrooxidation on nickel-based hydroxides, Nat. Commun. 14(1) (2023) 1686 (“Zhu 2023”).

What is claimed is:

1. A method for functionalizing polymers, comprising:
(a) preparing a slurry comprising a mixture of plastic particles and a carrier fluid;
(b) flowing the slurry into a multistage packed bed reactor, wherein:
(i) the multistage packed bed reactor comprises:
(A) one or more catalyst beds, wherein the one or more catalyst beds comprise a transition metal oxide catalyst selected from CuO, Cu₂O, NiO, Fe₂O₃, MnO₂, CoO, CrO, VO, transition metal oxides, and combinations thereof,
(B) an anode and a cathode, and
(C) in some embodiments a separator positioned between the anode and the cathode, and
(ii) the slurry is flown through at least one of the one or more catalyst beds;
(c) applying a voltage between the anode and the cathode to generate metal oxide catalysts in situ within the reactor;
(e) oxidizing the plastic particles in the slurry,
(f) introducing one or more functional groups comprising C—O, C═C, C═O, OH, and combinations thereof to create a functionalized polymer; and
(f) recovering the functionalized polymer.

2. The method of claim 1, wherein the carrier fluid is an electrolyte.

3. The method of claim 1 further comprising controlling the temperature within a range of 20° C. to 130° C. during the step of oxidizing the plastic particles in the slurry.

4. The method of claim 1, wherein the voltage is a pulsed potential modulated between −0.45 V and −0.25 V.

5. The method of claim 1, where the voltage controller is configured to use switching frequencies of about 5, 10, and 30 seconds.

6. The method of claim 1, wherein the functionalized polymer is further processed using electro-Fenton techniques to generate fatty acids, fuels, or monomers.

7. The method of claim 1, wherein the one or more functional groups comprise both the C═C and the C═O.

8. The method of claim 1, wherein the catalyst bed is in the form of a porous mesh or foam.

9. The method of claim 1 further comprising the step of recovering dissolved catalysts from the carrier fluid using electrodeposition.

10. The method of claim 1, wherein the plastic particles comprise low-density polyethylene (LDPE), polypropylene (PP), polyester, nylon, acrylic, polyvinyl chloride.

11. The method of claim 1, wherein the plastic particles have a particle size in the range of about 10 microns to about 2000 microns.

12. The method of claim 1, wherein the carrier fluid comprises an aqueous medium selected from the group consisting of potassium hydroxide, sodium hydroxide, sulfuric acid, copper sulfate, nickel sulfate, and combinations thereof.

13. The method of claim 1, wherein the carrier fluid further comprises an additive selected from the group consisting of lactic acid, ethylenediaminetetraacetic acid (EDTA), and surfactants.

14. A system for functionalizing polymers, comprising:
(a) a slurry reservoir configured to contain a slurry comprising plastic particles and a carrier fluid;
(b) a multistage packed bed reactor comprising:
(i) a plurality of stages, each stage containing:
(A) a catalyst bed containing a metal oxide catalyst selected from a group consisting of CuO, Cu₂O, NiO, Fe₂O₃, MnO₂, CoO, CrO, VO, transition metal oxides, and combinations thereof,
(B) an anode and a cathode, and
(C) in certain embodiments a separator positioned between the anode and cathode;
(c) a voltage controller operable to apply a voltage between the anode and cathode to generate in-situ metal oxide catalysts;
(d) a temperature controller operable to maintain a reaction temperature between 20° C. and 130° C.;
(e) a pump configured to flow the slurry through the reactor; and
(f) one or more product reservoirs operatively connected to the reactor to collect a functionalized polymer.

15. The system of claim 14, wherein the carrier fluid is an electrolyte.

13. The system of claim 14, wherein the voltage controller is configured to supply a pulsed potential modulated between −0.45 V and −0.25 V.

14. The system of claim 14, where the voltage controller is configured to use switching frequencies of about 5, 10, and 30 seconds.

15. The system of claim 14, wherein the catalyst bed is in the form of a porous mesh or foam.

16. The system of claim 14, wherein the plastic particles comprise low-density polyethylene (LDPE), polypropylene (PP), polyester, nylon, acrylic, polyvinyl chloride, or combinations thereof.

17. The system of claim 14, wherein the plastic particles have a particle size in the range of about 10 microns to about 2000 microns.

18. The system of claim 14, wherein the carrier fluid comprises an aqueous medium selected from the group consisting of potassium hydroxide, sodium hydroxide, sulfuric acid, copper sulfate, nickel sulfate, and combinations thereof.

19. The system of claim 14, wherein the carrier fluid further comprises an additive selected from the group consisting of lactic acid, ethylenediaminetetraacetic acid (EDTA), and surfactants.

20. A functionalized polymer product, produced by the method of claim 1, comprising:
(a) a polymer backbone comprising one or more functional groups selected from a group consisting of C—O, C═C, C═O, OH, and combinations thereof,
(b) wherein the one or more functional groups are introduced into the polymer backbone through an electrochemical process utilizing metal oxide catalysts selected from a group consisting of CuO, Cu₂O, NiO, Fe₂O₃, MnO₂, CoO, CrO, VO, transition metal oxides, and combinations thereof.
